(19) United States
(12) Patent Application Publication
(10) Pub. No.: US 2011/0158806 A1
(43) Pub. Date: Jun. 30, 2011

(54) Wind Turbines and Other Rotating Structures with Instrumented Load-Sensor Bolts or Instrumented Load-Sensor Blades

(76) Inventors: Steven W. Arms, Williston, VT (US); David L. Churchill, Burlington, VT (US); Jacob H. Galbreath, Burlington, VT (US); Thomas M. Leamon, Richmond, VT (US); David Maass, Guilford, CT (US); Christopher P. Townsend, Shelburne, VT (US)

(21) Appl. No.: 12/761,259

(22) Filed: Apr. 15, 2010

Related U.S. Application Data
(60) Provisional application No. 61/169,309, filed on Apr. 15, 2009.

(51) Int. Cl. F04D 27/00; H04W 4/00

(52) U.S. Cl. 416/31; 455/507

(57) ABSTRACT

A turbine includes a turbine blade, a plurality of sensors, a wireless sensor module, a data aggregator, and a blade pitch control unit. The plurality of sensors are distributed in a plurality of locations on the turbine blade suitable for determining a moment of the turbine blade. The sensor module is configured to transmit data to the data aggregator to determine the moment. The data aggregator is configured to provide an output to the blade pitch control unit. The blade pitch control unit is configured to adjust pitch of the turbine blade based on the moment.

### RELATED APPLICATIONS

This patent application claims priority of U.S. Provisional Patent Application 61/169,309 filed on Apr. 15, 2009 entitled “Wind Turbines and Other Rotating Structures with Instrumented Load Sensor Bolts or Instrumented Load Sensor Blades.”

This invention was made with Government support under contract number N68335-08-C-0099, awarded by the US Department of the Navy. The Government has certain rights in the invention.

### RELATED PUBLICATIONS

This application is related to the following publications, all of which are incorporated herein by reference:
1. Arms, S. W., Townsend, C. P., Galbreath, J. H., Churchill, D. L, Phan, N., “Synchronized System for Wireless Sensing, RFID, Data Aggregation, & Remote Reporting”, American Helicopter Society 65^{th} Annual Forum, Grapevine, Tex., to be published May 29-31, 2009
2. Arms, S. W., Townsend, C. P., Churchill, D. L., Galbreath, J. H., Corneau, B, Ketcham, R. P., Phan, R., “Energy Harvesting, Wireless, Structural Health Monitoring and Reporting System”, 2nd Asia-Pacific Workshop on SHM, Melbourne, Dec. 2-4, 2008
3. S. W. Arms, J. H. Galbreath, C. P. Townsend, D. L. Churchill, B. Corneau, R. P. Ketcham, Nam Phan, “Energy Harvesting Wireless Sensors and Networked Timing Synchronization for Aircraft Structural Health Monitoring,” to be published in the conference proceedings of the First International Conference on Wireless Communications, Vehicular Technology, Information Theory and Aerospace & Electronic Systems Technology (Wireless VITAE), May 17-20, 2009, Aalborg Congress and Culture Centre, Aalborg, Denmark

### OTHER RELATED PATENTS AND PATENT APPLICATIONS

This application is also related to the following patents and patent applications, all of which are incorporated herein by reference:
1. U.S. Pat. No. 3,695,096 Strain detecting load cell
2. U.S. Pat. No. 4,283,941 Double shear beam strain gauge load cell
3. U.S. Pat. No. 4,364,280 Double shear beam strain gauge load cell
4. U.S. Pat. No. 7,188,535 Load cell having strain gauges of arbitrary location
5. U.S. Pat. No. 6,629,446 Single vector calibration system for multi-axis load cells and method for calibrating a multi-axis load cell
6. U.S. Pat. No. 7,170,201 Energy harvesting for wireless sensor operation and data transmission
7. U.S. Pat. No. 7,081,693 Energy harvesting for wireless sensor operation and data transmission
8. U.S. Pat. No. 7,143,004 Solid state orientation sensor with 360 degree measurement capability
9. U.S. Pat. No. 6,871,413 Miniaturized inclinometer for angle measurement with accurate measurement indicator
10. U.S. Pat. No. 6,529,127 System for remote powering and communication with a network of addressable, multichannel sensing modules
11. U.S. Pat. No. 5,887,351 Inclined plate 360 degree absolute angle sensor
12. 20050146220 Energy harvesting for wireless sensor operation and data transmission
13. 20050140212 Energy harvesting for wireless sensor operation and data transmission
14. 20050116545 Energy harvesting for wireless sensor operation and data transmission
15. 20050116544 Energy harvesting for wireless sensor operation and data transmission
16. 20050105231 Energy harvesting for wireless sensor operation and data transmission
17. 20040078662 Energy harvesting for wireless sensor operation and data transmission
18. 20060103534 Identifying substantially related objects in a wireless sensor network
19. U.S. patent application Ser. No. 09/731,066 Data Collection and Storage Device (Attorney Docket number 1024-034)
20. U.S. patent application Ser. No. 09/768,858 & U.S. patent application Ser. No. 10/215,752 (divisional) Micropower Differential Sensor Measurement (Attorney Docket number 1024-037)
21. U.S. Pat. No. 7,256,505 Shaft mounted energy harvesting for wireless sensor operation and data transmission (attorney docket number 115-014), (“the '505 patent”)
22. U.S. patent application Ser. No. 11/084,541 Wireless Sensor System (attorney docket number 115-016)
23. U.S. patent application Ser. No. 11/091,244 Strain Gauge with Moisture Barrier and Self-Testing Circuit (attorney docket number 115-017), (“the '244 application”)
24. U.S. patent application Ser. No. 11/260,837 Identifying substantially related objects in a wireless sensor network (attorney docket number 115-018)
25. U.S. patent application Ser. No. 11/368,731 and 60/659,338 Miniature Acoustic Stimulating and Sensing System, (attorney docket nos. 115-019 & 115-028)
26. U.S. patent application Ser. No. 11/604,117, Slotted Beam Piezoelectric Composite Structure, (attorney docket number 115-022), (“the '117 application”)
27. U.S. patent application Ser. No. 11/585,059, Structural damage detection and analysis system (attorney docket number 115-036)
28. U.S. patent application Ser. No. 11/518,777, Energy Harvesting Wireless Structural Health Monitoring System (attorney docket number 115-030), (“the '777 application”)
29. 60/898,160 Wideband Energy Harvester, (attorney docket number 115-052)
30. 60/497,171 A Capacitive Discharge Energy Harvesting Converter (attorney docket number 115-051)
31. U.S. patent application Ser. No. 12/360,111, “Independently Calibrated Wireless Structural Load Sensor,” docket number 115-059, filed Jan. 26, 2009 (“the '111 application.”).

### REFERENCES

This application is also related to the following reference publications, all of which are incorporated herein by reference:
1. Selvam, K., “Individual Pitch Control for Large Scale Wind Turbines, Multivariable Control Approach”, Masters Thesis, Energy Research Center of the Netherlands, TU Delft, ECN-E-07-053, Jul. 25, 2007.
2. Van der Hooft, E., P. Schaak and van Engelen, T., “Wind turbine control algorithm. Report ECN-C-03-111, ECN, 2003.
3. Van Engelen, T., “Design Model and Load Reduction Assessment for Multi-rotational Mode Individual Pitch Control (Higher Harmonics Control)”, European Wind Energy Conference. Athens, Greece, 2006.
4. Van Engelen, T., “Control design based on aero-hydro-servo-elastic linear models from TURBU”, European Wind Energy Conference, Milano, Italy, 2007.
5. Van Engelen, T. and Van der Hooft, E., “Individual Pitch Control Inventory”, Report ECN-C-03-138, ECN, 2003.

### FIELD

This patent application generally relates to a system for monitoring a wind turbine. More particularly it relates to a system for monitoring forces and moments on blades and tower of the wind turbine. It also relates to an energy harvesting system for providing power for uses such as monitoring and transmitting data.

### BACKGROUND

The vast majority of the wind turbines on the market are composed of horizontal axis, upwind, three-bladed wind turbine designs, as shown in FIG. 1. Wind turbine blades 30 are manufactured with a series of bolts 32 projecting from circular blade root 34, as shown in FIG. 2. Blades 30 are attached to central rotor hub 36 of wind turbine 37, as shown in FIG. 3, by mating the blades' bolts 32 with a series of clearance holes 38 on retaining hub flange 40 on hub 36 using nuts (not shown) to secure retainer bolts 32. These connections are often performed while blades 30 and hub 36 are on the ground, as shown in FIG. 4. Typically bolts 32 are preloaded in tension to assure a good mechanical joint between hub flange 40 and blade flange 42. Retaining hub flange 40 is then mounted to large bearing 44 in rotor hub 36 with attached control system 46, as shown in FIG. 5, to control blade pitch angle.

However, systems for measuring forces on the blades that feed control system 46 have not been adequate, and the present patent application provides improvement.

### SUMMARY

One aspect of the present patent application is a turbine that includes a turbine blade, a plurality of sensors, a wireless sensor module, a data aggregator, and a blade pitch control unit. The plurality of sensors are distributed in a plurality of locations on the turbine blade suitable for determining a moment of the turbine blade. The sensor module is configured to transmit data to the data aggregator to determine the moment. The data aggregator is configured to provide an output to the blade pitch control unit. The blade pitch control unit is configured to adjust pitch of the turbine blade based on the moment.

### BRIEF DESCRIPTION OF THE DRAWINGS

FIG. 1 is a three dimensional view of a prior art wind turbine;

FIGS. 2a-2b are three dimensional views of prior art wind turbine blades showing the blade root with bolts extending for attaching the blade to a hub;

FIG. 3 is a three dimensional view of a prior art hub including the hub attachment flange with its series of clearance holes that accept the blade's bolts;

FIG. 4 is a three dimensional view of a prior art wind turbine blade and hub, both resting on the ground ready for connection;

FIG. 5 is a three dimensional view of a prior art blade pitch control mechanism installed in a hub;

FIG. 6 is a schematic diagram of a blade showing the blade root, the rotor blade reference axis, and the orientation of flapping and edgewise (lead-lag) moments;

FIG. 7 is a schematic diagram of an embodiment of a blade root with smart fasteners, such as instrumented load-sensor bolts, the bolts having load sensors, and the bolts positioned for measuring blade root moments;

FIG. 8 is a schematic diagram illustrating how the measurements of the three axial loads provided by the smart fasteners are used to solve for centrifugal load and the two moments;

FIG. 9a is a front view of a wind turbine mounted on a tower illustrating how gravity loads are used to calibrate the load sensors under conditions when wind loads are minimal;

FIG. 9b is a cross sectional view of a blade of the wind turbine of FIG. 9a also illustrating how gravity loads are used to calibrate the load sensors under conditions when wind loads are minimal;

FIGS. 10a-10c are graphs showing the flap and edgewise gravity induced blade moments as a function of blade rotation position for three different pitch angles of the blade;

FIG. 11 is a block diagram showing the prior art conversion of blade moments to blade pitch commands, as provided in reference 1, page 43;

FIG. 12a is a block diagram showing the components of the wireless bolt tension and compression sensing node that is included in each of the smart fasteners;

FIG. 12b is a block diagram showing the components of the wireless data aggregator node;

FIG. 12c is a block diagram showing the components of the wireless vibration sensing node that may also be included in each of the smart fasteners;

FIG. 12d is a block diagram of an energy harvesting, wireless system including components of a wireless sensor data aggregator (WSDA);

FIG. 13 is a top view of a printed circuit board with the components of the wireless bolt tension and compression sensing node of FIG. 12a for high sample rate with FRAM memory;

FIG. 14a is a top view of an embodiment of an instrumented load-sensor bolt smart fastener showing the instrumentation housing;

FIG. 14b is a cross sectional view of an embodiment of an instrumented load-sensor bolt smart fastener showing the location of the sensors in the pin region of the bolt and the instrumentation housing with its wire connectors, printed circuit boards, battery, and antenna;

FIG. 14c is a three dimensional view of an embodiment of an instrumented load-sensor bolt smart fastener showing the location of the sensors in the pin region of the bolt for a full bridge strain gauge set-up with two strain gauges on each side of the bore in the bolt;

FIG. 14c is a cross sectional view of the embodiment shown in FIG. 14c;

FIG. 15a is an exploded view of an embodiment of an energy harvesting instrumented load-sensor with a flexure mounted for receiving vibrational energy through a base, a printed circuit board and energy storage units for receiving and storing the energy;

FIG. 15b is an exploded view of the mounting portion of the energy harvesting instrumented load-sensor of FIG. 15a with the accelerometer attached to the mounting bolt with an isolating elastomeric gasket;

FIG. 16a is an exploded view of an embodiment of an energy harvesting unit with magnets that can move within a coil to generate electricity from vibrational energy in a shaft to which the energy harvesting unit is mounted;

FIG. 16b is a three dimensional view of the assembled vibration energy harvester of FIG. 16a;

FIG. 17 shows an image of the magnetic flux lines from the opposing magnets that are the inside coils of the arrangement of FIGS. 16a-16b.

FIG. 18a is a three dimensional view of another embodiment of a vibration energy harvester configured in the size and shape of a battery;

FIG. 18b is a three dimensional cross sectional view of the embodiment of a vibration energy harvester that uses magnets vibrating in coils to convert vibrational energy into electricity;

FIG. 18c is a schematic diagram of the magnetic flux lines of two magnets of FIGS. 18a-18b facing each other;

FIG. 19a is a block diagram showing the components of an energy harvesting circuit for receiving energy from an energy harvesting unit, converting to a useful voltage, storing the energy, and providing it to an application load;

FIG. 19b is a block diagram of a WSDA and timing control for its associated hard-wired and wireless sensor nodes;

FIG. 20 is a three dimensional view of a central hub data collection scheme for collecting data from each blade first in a hub data collection unit in the rotating hub and then transmitting that data from the hub data collection unit in the central hub to a stationary WSDA box;

FIG. 21 is a three dimensional view of a central hub data collection scheme for collecting data from each blade in which each smart fastener transmits data directly to a stationary WSDA box;

FIG. 22 is a cross sectional view of a central hub data collection scheme for collecting data from each blade first in a hub data collection unit in the rotating hub and then transmitting that data from the hub data collection unit in the central hub to a stationary WSDA box in which the hub data collection unit uses an external hub fairing antenna or an internal hub fairing antenna that is located in a portion of the hub made of a material that allows transmission;

FIG. 23 is a three dimensional view of a prior art Rotabolt bolt load sensor;

FIGS. 24a-24b are cross sectional views of an embodiment of an instrumented load-sensor bolt smart fastener showing a DVRT in the pin region of the bolt and the instrumentation housing with its wire connectors, printed circuit boards, battery, and antenna;

FIG. 25 is a three dimensional view of a prior art ultrasonic bolt load sensor;

FIG. 26 is a three dimensional view of a wind turbine blade with wireless strain gauges mounted inside;

FIG. 27 is a timing diagram illustrating the wireless time synchronization beacon and the sensor data packet transmission timing for two nodes;

FIG. 28a is a front view of a wind turbine with wireless strain gauges mounted inside the tower; and

FIG. 28b is a side view of the wind turbine of FIG. 28a with wireless strain gauges mounted inside the tower.

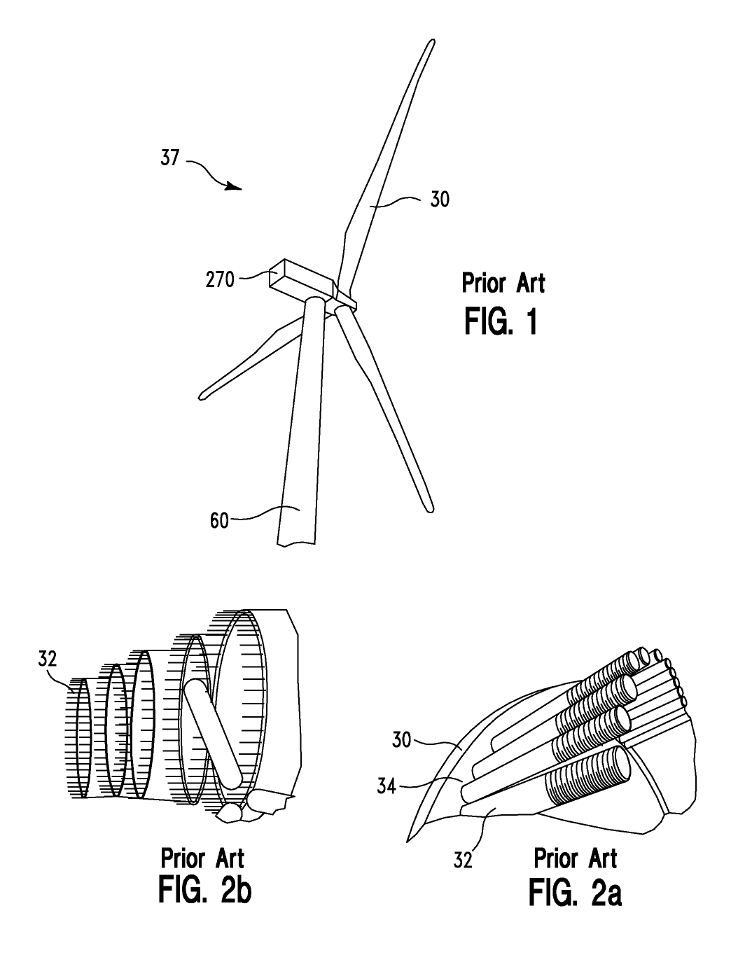

### DETAILED DESCRIPTION

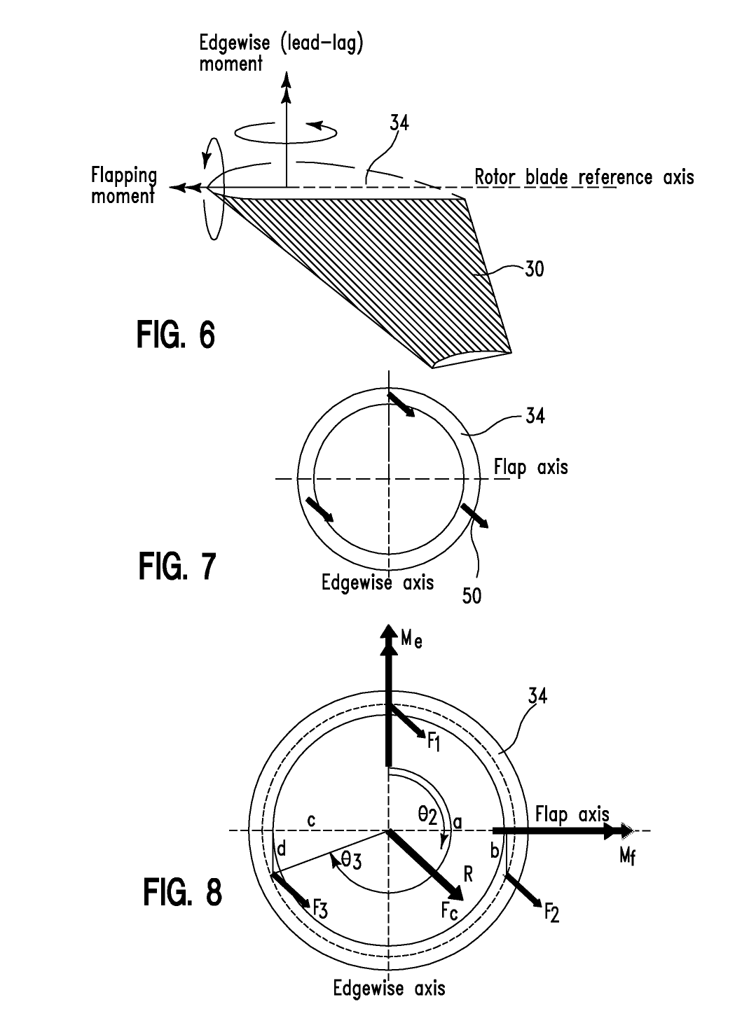

The present applicants recognized that the aerodynamic forces generated by moving blade 30 result in two moments at blade root 34 that are reacted by hub 36—a flapping moment generated by lift forces normal to the rotor plane, and an edgewise or lead-lag moment generated by aerodynamic forces parallel to the rotor plane, as shown in FIG. 6.

Monitoring the real time status of the two blade moments can yield a great deal of useful information, especially combined with other turbine state data, such as the blade rotation angle, rotation rate, collective pitch setting, and wind velocity. Some of the operating characteristics that can be inferred from direct blade moments include:
Instantaneous applied blade loads
Blade load contribution to the generator shaft (not shown) yawing moment (i.e. the shaft bending causing wind turbine 37 to turn about its vertical or azimuth axis)
Blade load contribution to the generator shaft tilting moment (i.e. the shaft bending causing wind turbine 37 to tilt up or down about a horizontal axis)

The present applicants found that they could obtain a direct measurement of forces produced by a blade by using smart fasteners, such as instrumented load-sensor bolts. Instrumented pins, studs, or other smart fasteners can also be used. Strain sensors applied to the interior surface of the blades could also be used. The measured forces could then be used to determine blade moments. Applicants recognized that this directly measured determination of blade moments was superior to calculating moments based on other measurable parameters, such as the average wind velocity.

In this application a phrase such as “the sensor is on the turbine blade” means that the sensor is mounted to any portion of the blade, including an interior surface. In addition the phrase “the sensor is on the turbine blade” includes the sensor being mounted on a device that is itself mounted on the blade, such as a bolt that holds the blade to a hub.

Applicants also recognized that the improved measurement of operating loads on the blade and better load control allows designers the freedom to operate each of the blades closer to its limits, for example at higher wind conditions. This results in reduced electrical generation cost because more electricity can be generated from a given investment in equipment (electrical generation cost is largely amortization of the original equipment cost). Furthermore, improved measurement of applied blade load and better load control leads to reduced scheduled and unscheduled maintenance and increased wind turbine reliability. Both of these lead to decreased cost of electrical generation.

In addition, by monitoring the change in blade moments over time at different operating conditions, the present applicants could also infer:
Presence of blade icing, which is an operating hazard
Presence of rotor blade structural damage and damage propagation
Rotor imbalance

Additional sensors, such as accelerometers, can be used to detect abnormal vibration in the gear box that may indicate an abnormal condition, such as a broken tooth. These sensors are synchronized, as described herein below, with sensors measuring loads on the blades so the load conditions on the rotor can be related to conditions measured on the gear box.

### Implementation

In one embodiment, at least three smart fasteners, such as instrumented load-sensor bolts 50, are used to measure moments blade 30 is applying to blade root 34, as shown in FIG. 7. In general, retaining bolts 32, including instrumented load-sensor bolts 50, react three forces—blade centrifugal load F_{c}, flapping moment M_{f}, and edgewise moment Mₑ. At least three load sensors are used to solve for the three unknowns. In another embodiment, more than three load sensors are used. This redundancy improves the accuracy and resolution of the measurement of blade centrifugal load and the blade moments.

Referring to FIG. 8:

F₁, F₂, F₃ Axial forces in the three bolts
R Radius of the bolt circle
θ₁, θ₂, θ₃ Angular position of the instrumented bolts (θ₁=0 for convenience)
F_{c} Blade centrifugal force
M_{f} Blade flapping moment
Mₑ Blade edgewise moment

It can be shown that

$$\{ \begin{matrix}{F}_{c} \\ {M}_{f} \\ {M}_{e}\end{matrix} \} = [ \begin{matrix}1 & 1 & 1 \\ R & - b & - d \\ 0 & - a & c\end{matrix} ] \{ \begin{matrix}{F}_{1} \\ {F}_{2} \\ {F}_{3}\end{matrix} \} \qquad Eq . ( 1 )$$

Where:

a=—R cos θ₂
b=—R sin θ₂
c=—R cos θ₃
d=—R sin θ₃

In the general case of 4 instrumented load-sensor bolts 50 oriented at θ₁, θ₂, θ₃, and θ₄, the equation to be solved is:

$$\{ \begin{matrix}Fc \\ Mf \\ Me\end{matrix} \} = [ \begin{matrix}1 & 1 & 1 & 1 \\ R cos θ & R cos {θ}_{2} & R cos {θ}_{3} & R cos {θ}_{4} \\ R sin {θ}_{1} & R sin {θ}_{2} & R sin {θ}_{3} & R sin {θ}_{4}\end{matrix} ] \{ \begin{matrix}{F}_{1} \\ {F}_{2} \\ {F}_{3} \\ {F}_{4}\end{matrix} \} \qquad Eq . ( 2 )$$

Since measurement errors in the load sensors F₁ . . . Fₙ, are randomly distributed about a zero mean, the more load sensors in the aggregate measurement, the greater the self-canceling effect of these errors, and the better the measurement accuracy of the moments of interest.

In any bolted joint, there is load sharing between the bolt itself and the contact interface. In the current wind turbine application, the contact interface is where surface 52 of blade flange 42 at root 34 of blade 30 contacts hub flange 40 on hub 36. Measuring only the load in instrumented load-sensor bolt 50 does not provide a complete estimate of the load in the bolted joint overall. The load in the bolt will be some fraction of the overall joint load. The value of this fraction will depend on the relative stiffness of the bolt in comparison to that of the contact interface. This fraction can be determined through analysis, for example using finite element analysis techniques. It can also be taken into account through calibration. In the above descriptions, the applicants recognized that a correction for this load sharing is made to compute the desired aerodynamic blade loading. In particular, each of the bolt loads, Fi, is scaled by the inverse of its load sharing fraction as determined by the calibration coefficients or by the finite element analysis.

The solutions defined above assume that the bolted connection between blade 30 and hub 36 consist exclusively of instrumented load sensor bolts 50. In one embodiment only a small fraction of the bolt attachments are instrumented load sensor bolts. The non-instrumented bolts 32 share in the load transfer between blade 30 and hub 36. Therefore, the equations noted above apply only for that portion of the loads being carried by instrumented load-sensor bolts 50. The measured centrifugal load determined above is proportional to the total centrifugal load according to the ratio of the number of instrumented load-sensor bolts 50 to the total number of bolts 32.

$${F}_{C} = ( \frac{N}{n} ) * {F}_{c} where \qquad Eq . ( 3 )$$

F_{C}=Total centrifugal load
F_{c}=Centrifugal load carried by bolt sensors per Eq. 2
N=Total number of bolts
n=Number of sensor bolts

To determine the total flapwise and edgewise moment, it is first necessary to solve for all the bolts' loads. It can be shown that:

Fᵢ=A*sin(θᵢ+β)+K where Eq. (4)

Fᵢ=bolt load of the i^{th} bolt
θᵢ=Orientation of the i^{th} bolt
β=phase angle
K=Mean of F₁, F₂, F₃ measured instantaneous AXIAL sensor loads

### A=Amplitude

$$\begin{matrix} A = [ \frac{{F}_{1} - {F}_{2}}{sin ( {θ}_{1} - β ) - sin ( {θ}_{2} - β )} ] & Eq . ( 5 ) \\ β = {tan}^{- 1} ( \frac{{M}_{f}}{{M}_{e}} ) where {M}_{f} and {M}_{e} are as determined in Eq . 1 or 2 & Eq . ( 6 )\end{matrix}$$

Once all bolt loads are determined, the total flapwise and edgewise moment arising from the bolts can be determined:

$${M}_{F} = [ \begin{matrix}{F}_{1} & {F}_{2} & … & … & … & {F}_{N}\end{matrix} ] * R \{ \begin{matrix}cos {θ}_{1} \\ cos {θ}_{2} \\ … \\ … \\ … \\ cos {θ}_{N}\end{matrix} \} where \qquad Eq . ( 7 )$$

M_{F}=Total flapping moment
Fᵢ, θᵢ=Bolt loads and positions for i=1 to N (total number of bolts)

Similarly, for the edgewise moment:

$${M}_{E} = [ \begin{matrix}{F}_{1} & {F}_{2} & … & … & … & {F}_{N}\end{matrix} ] * R \{ \begin{matrix}sin {θ}_{1} \\ sin {θ}_{2} \\ … \\ … \\ … \\ sin {θ}_{N}\end{matrix} \} where \qquad Eq . ( 8 )$$

M_{E}=Total edgewise moment

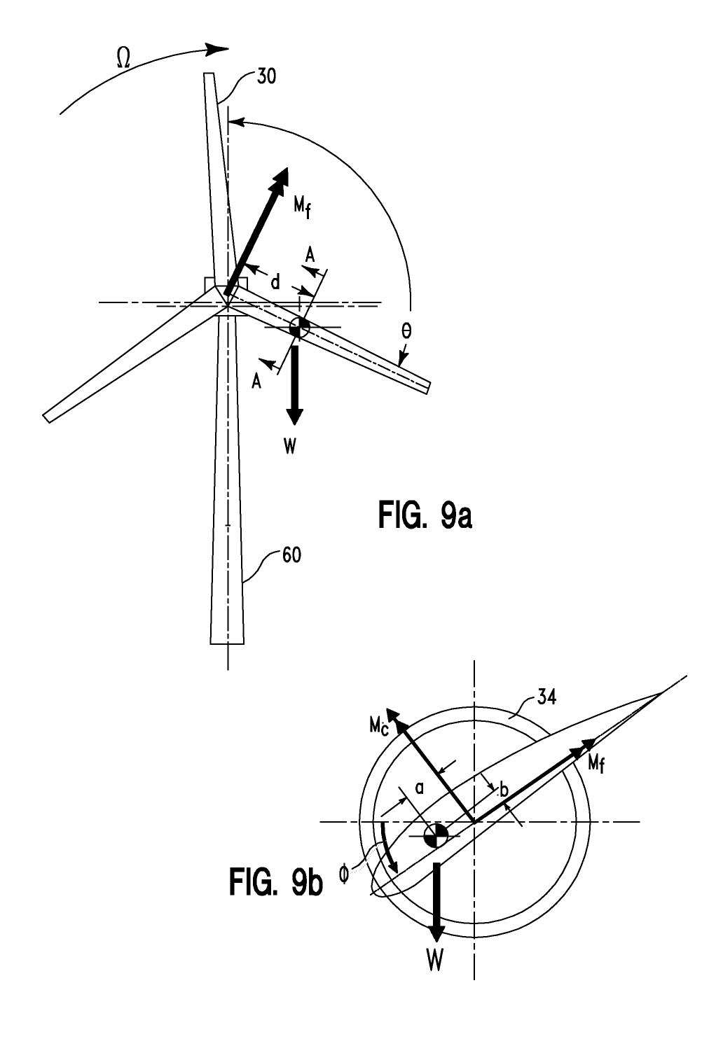

Retaining bolts 32 are bolted into hub 36 with a preload. In one embodiment this preload is measured in a calibration step, and calibration coefficients so determined are used to properly measure blade operating load. The bolt forces calculated above are those forces in the bolts above and beyond those created by preloading the bolts upon installation. Furthermore, the 1 g gravity loads on the blade result in significant root moments as well, and calibration is used to properly isolate the blade aerodynamic loads in operation. Calibration can be performed as described below, with reference to FIG. 9.

For a given blade rotation position θ and pitch angle φ, it can be shown that:

M_{f}=Wd(sin θ cos φ+b cos θ) Eq. (9)

Mₑ=Wd(−sin θ sin φ+a cos θ) Eq. (10)
Where a, b=offsets of the blade CG (center of gravity) from the center of the pitch rotation ring
   W=blade weight
   d=distance from Blade CG to root bolt ring

Note that for the sake of simplicity, the blade coning angle and the shaft tilt angle have been assumed to be zero. These equations can be modified to account for these effects.

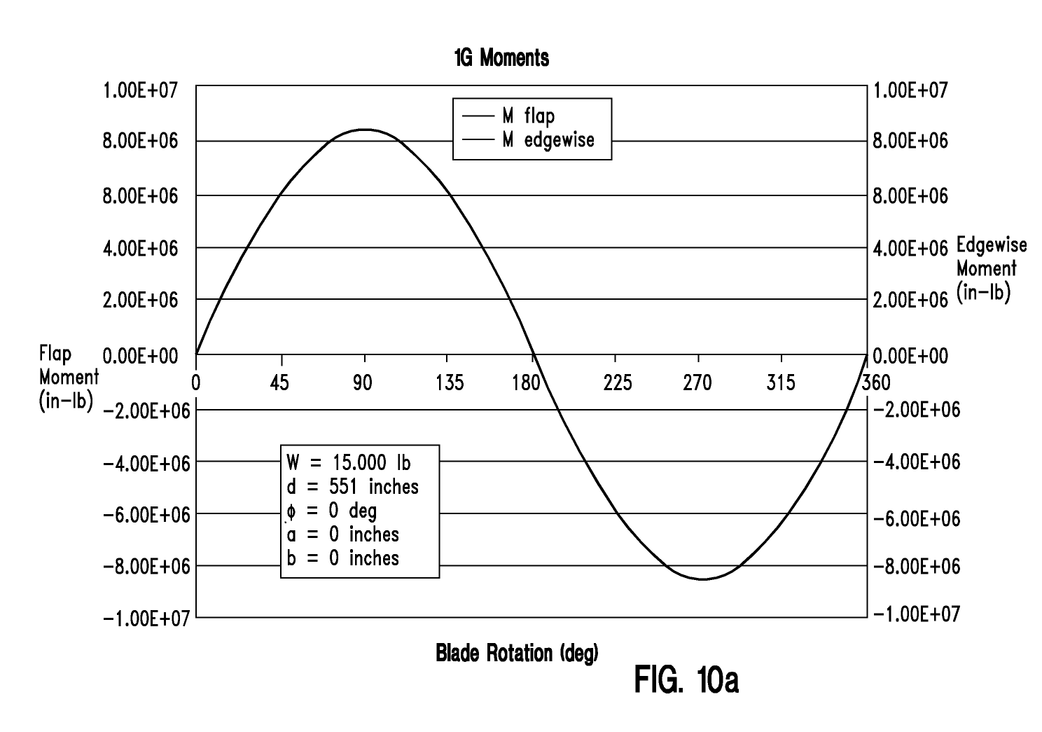

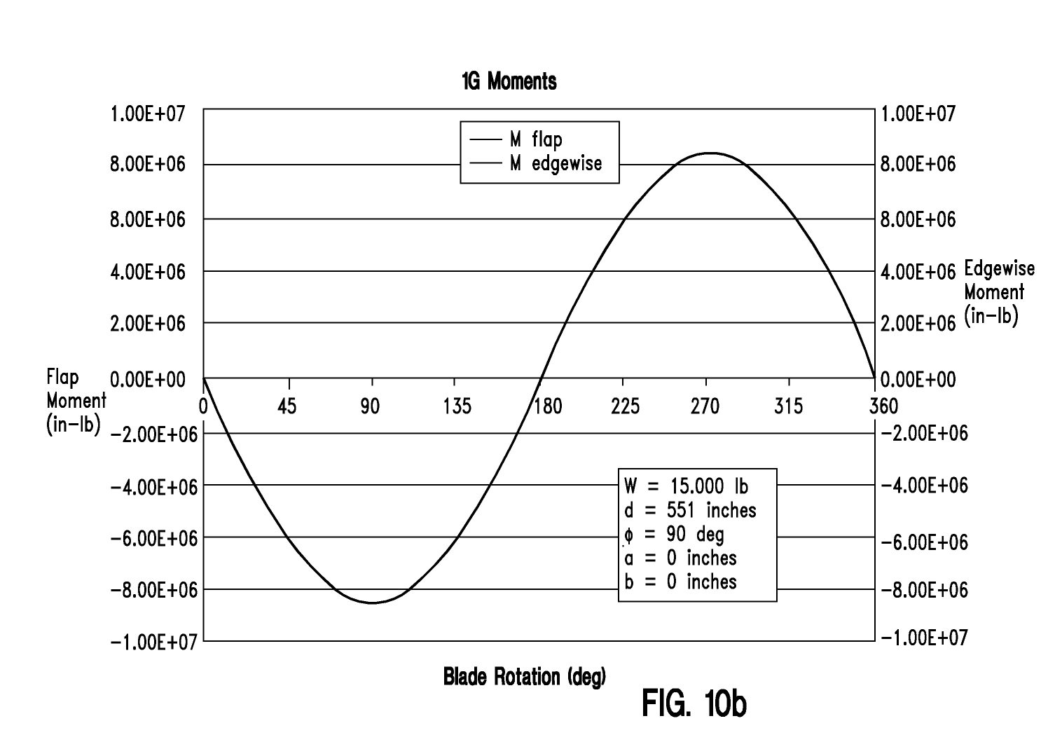

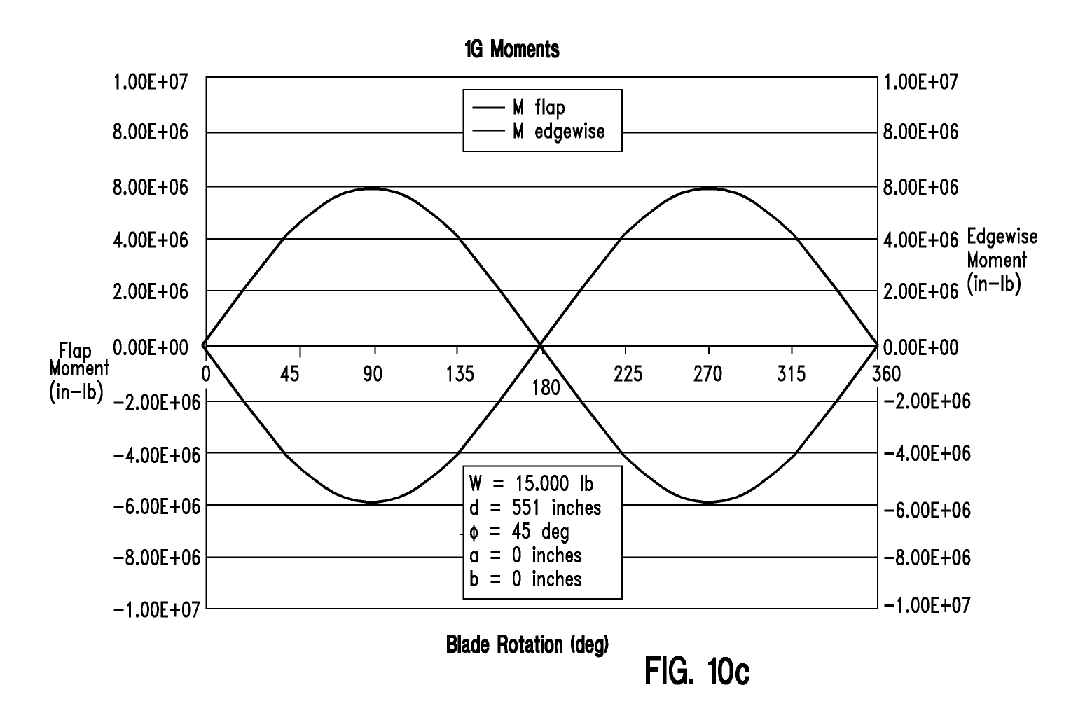

As shown in FIG. 10, 1 G root moments M_{f} and Mₑ vary with blade rotation position and pitch angle. Since all of the parameters in equations (9) and (10) for each blade 30 are known, we can calculate the sensor bolt loads F₁ . . . Fₙ using the inverse of Equations (1) (for 3 sensors) or Equation (2) (for N sensors).

To calibrate the load sensors for the effect of preload and 1 G gravity loads: in one embodiment instrumented load-sensor bolts 50 are factory calibrated before installation, and calibration coefficients found in the factory calibration are used directly to determine the preload applied to each bolt upon installation. These values are stored.

To measure 1 G gravity loads, sensor measurements are taken when no aerodynamic loads are present (i.e. when the wind velocity is zero or some very small value (perhaps 1 knot). Applicants recognized that since aerodynamic loads are proportional to the square of the wind velocity, loads at 1 knot wind speed are about 0.44% of the loads at 15 knots.

To determine 1 G gravity loads as per FIG. 9, the rotor (not shown) is held in a fixed rotation position θ using the rotor brake (not shown) under zero wind conditions, holding the blades in fixed position as well. The blade pitch angle φ for each blade 30 is then varied over the range of −90 degrees to +90 degrees, and the sensor loads are measured. These are converted to 1 G gravity flapwise and edgewise moments using Eq. (9) and (10) and are stored.

In operation (i.e. in the presence of wind and with the rotor turning), the sensor forces are measured as shown in FIG. 8, and the instantaneous blade forces and moments are calculated per Eqs. (1), (2), (7) and (8) representing the total bolt forces and moments. To derive the aerodynamic loads and moments, the instantaneous 1 G gravity loads and moments (for that blade position θ and pitch angle φ) are subtracted from the total force and moment, yielding the force and moments associated exclusively with the applied aerodynamic load.

Applicants recognized that individual conventional bolts 32 may be removed after blade 30 has been bolted in place. In one embodiment, conventional bolts 32 are replaced with instrumented load-sensor bolts 50 without removing the rotor and blades 30 from tower 60, thus avoiding a disassembling and reassembling operation for previously assembled wind turbines. Applicants recognized that this retrofit capability can therefore save time and money. In one embodiment instrumented load-sensor bolts 50 are recalibrated after installation to take into account preload, gravity, and joint load sharing as described above.

### Blade Pitch Control

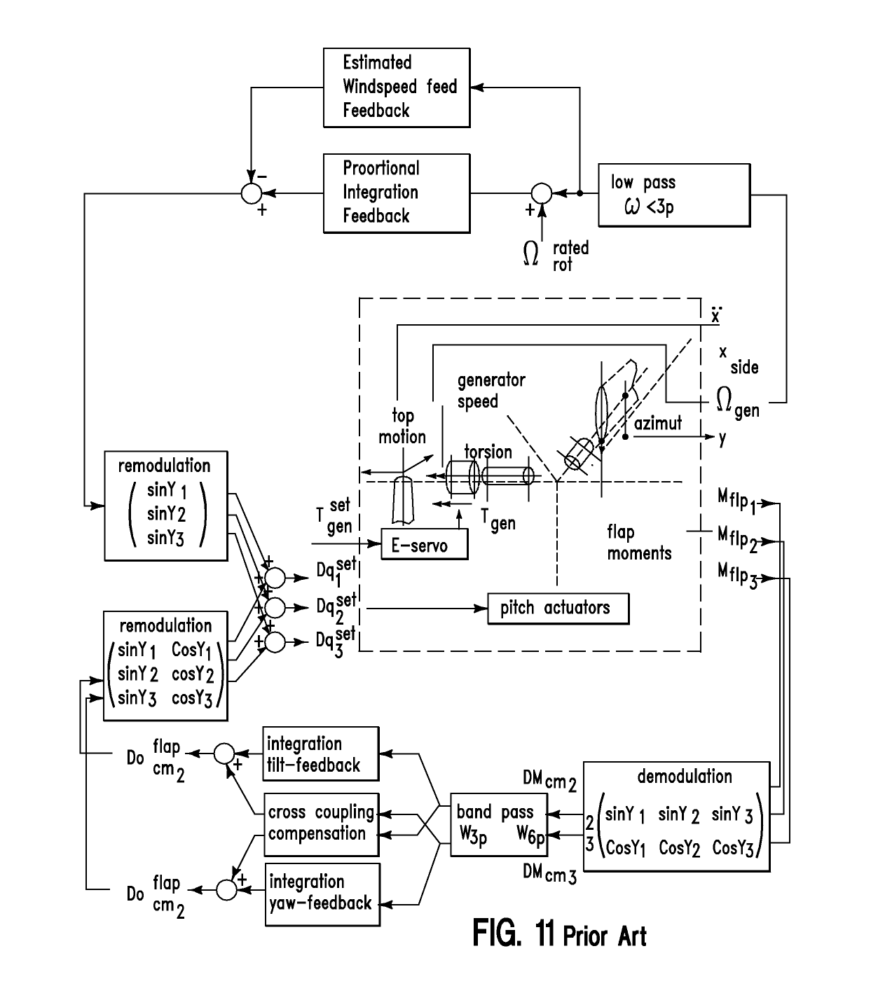

In one embodiment, the load sensor outputs of instrumented load-sensor bolts 50 are processed in processor 62 and transmitted to data aggregator 90 for computation of flapping moments M_{flp}, as described herein above and in equations 5-8. These moments are then used by data aggregator 90 to determine blade servo pitch commands for each blade 30, as illustrated in the block diagram in FIG. 11. In this embodiment, the rotor rotation rate, Ω, is provided by a shaft speedometer sensor (not shown).

The rotating flapping moments are converted into the stationary d-q (direct and quadrature) axes using the “d-q axis transformation”, which permits classical SISO (Single Input Single Output) control theory to be applied, as described in References 1-5.

Blade pitch control is used for two purposes. First, adjusting pitch enables extracting energy more efficiently from the prevailing winds. This improves the “capacity factor” (i.e. the fraction of the full electrical generating capacity of the turbine that it actually produces given variable ambient winds. Higher capacity factor and higher AEP (annual energy production) reduces the COE (cost of energy) produced, since the majority of this cost is amortization of the fixed turbine capital expense over the total energy produced.

A second purpose of load-based blade pitch control is to permit reduced safety factors in the design of the blade, which leads to lower blade weight and cost. In the absence of a load measurement and active control scheme, blades are designed using more conservative design margins to account for gusts and other randomly distributed wind loads. With load monitoring and control, these margins can be reduced because the system actively manages blade loads. Rotor blade costs are proportional to weight, so more structurally efficient (i.e. lighter) blades reduce the turbine capital cost and the COE.

### Load Sensor Implementation

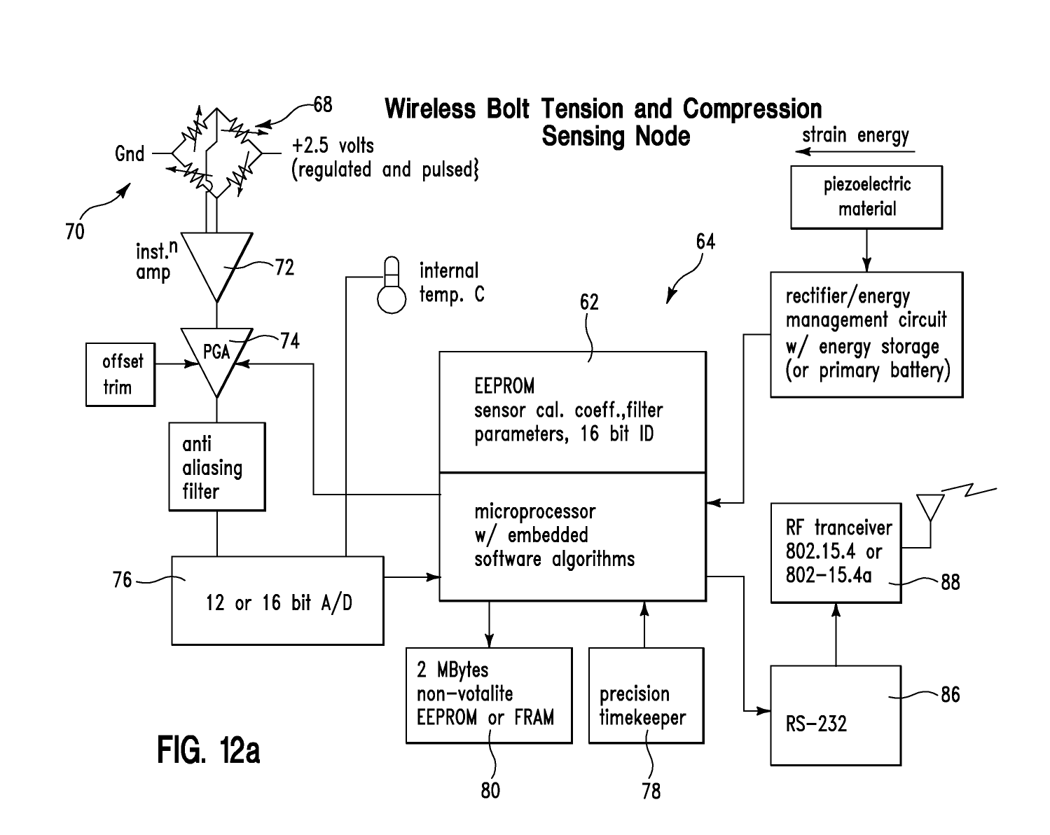

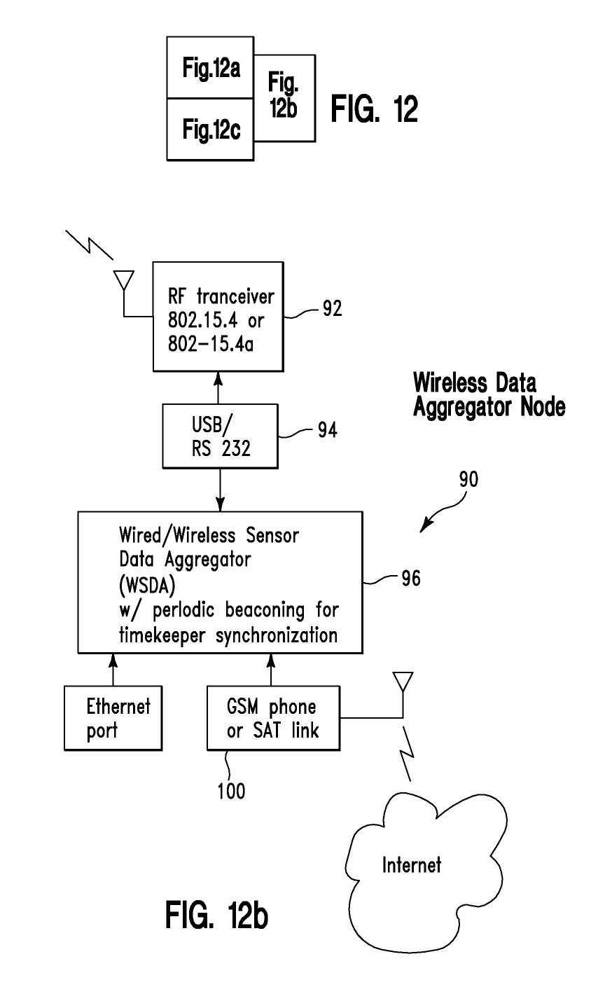

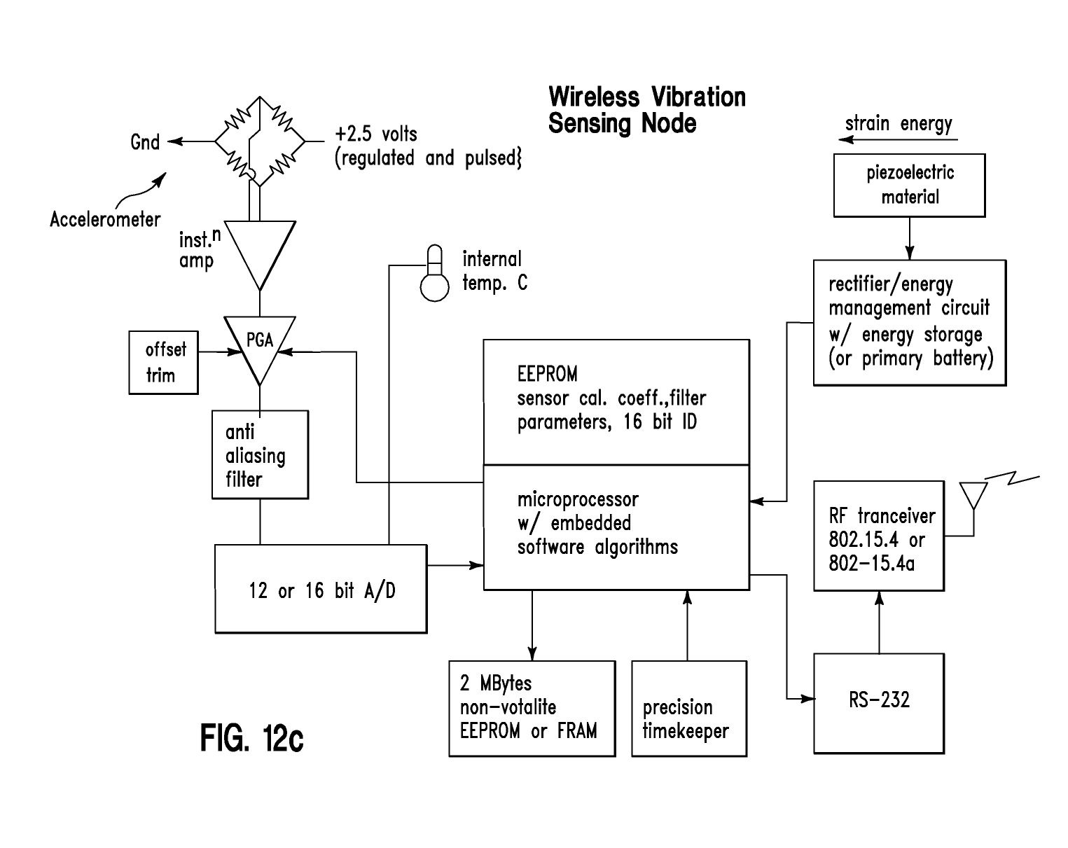

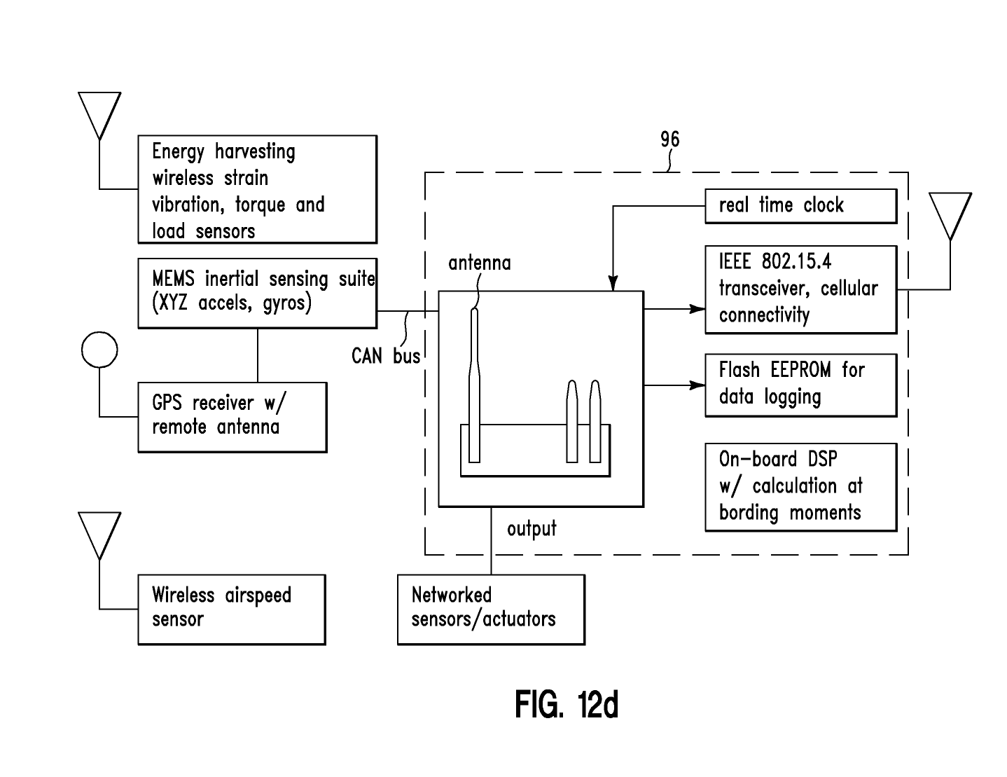

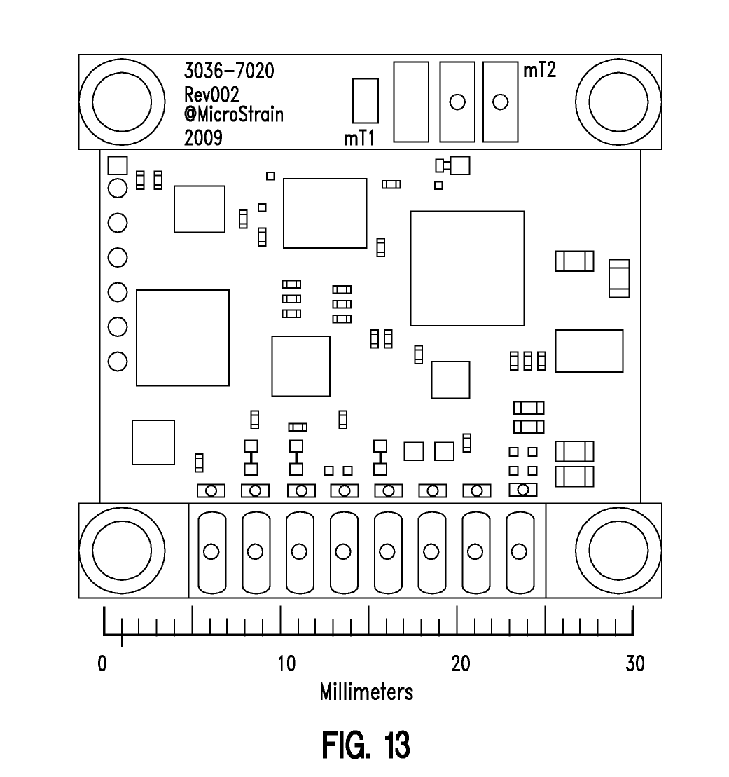

In one embodiment the wireless bolt tensioning and compression sensing node 64 within each instrumented load-sensor bolts 50 each includes circuit board 66 with components as shown in FIG. 12a and FIG. 13. strain sensors 68 are connected to form Wheatstone bridge 70 and are bonded within instrumented load-sensor bolt 50 in an arrangement sensitive to tensile and compressive strains within the bolt and to cancel temperature, bending, and torsional effects. This signal is amplified by instrumentation amplifier 72 and programmable gain amplifier (PGA) 74. The processor can adjust the gain on PGA 74 and can adjust the offset of bridge 70 and maximize its usable range, preventing saturation of PGA 74 and get the most range from A/D converter 76. Data is digitized in 12 or 16 bit A/D converter 76, such as the 16-bit TI ADS8319 A/D converter, Texas Instruments, Dallas, Tex., and provided to microprocessor 62 along with a time stamp from precision timekeeper 78. Data is adjusted with calibration coefficients that were stored in non-volatile EEPROM 80 and logged in a non volatile memory such as an EEPROM or FRAM, such as the FM25H20 from Ramtron, Inc.

Data is transmitted over a wired or wireless link such as RS-232 port 86 or RF-transceiver 88 to wireless sensor data aggregator node (WSDA) 90 that includes transceiver 92 or USB or RS 232 port 94, as shown in FIG. 12b. WSDA 96 provides periodic beaconing and includes a single board computer and a timekeeper as well as output ports such as Ethernet 98, GSM phone, and satellite link 100 for connecting to the internet, as shown in FIG. 12b. The WSDA is based on the Intel® IXP425 XScale® network processor. The IXP425 is an implementation of the ARM compliant, Intel XScale microarchitecture combined with communication peripherals including, 2 high speed Ethernet MACs, hardware accelerated cryptography, 2 high speed serial ports, a local PCI interface and DMA controller, as described in the '777 application.

Use of the FRAM is particularly useful for applications that use high speed sampling. A high sample rate (HSR) node was designed by MicroStrain, Inc. to log data at 50 kilosamples per second (kSPS) with 12-bit A/D converter resolution. The HSR node can be configured to sample a full differential Wheatstone bridge input (strain gauges, accelerometers, pressure sensors, etc.) or a single-ended 0-3 volt input. Each high rate logging event may consist of 125,000 samples, or ˜2.25 seconds of record time when sampled at 50 kSPS. The node can store up to 1 million samples on its embedded, non-volatile memory chip, as shown in FIG. 13. Use of the FRAM is also particularly useful for applications that use a circular buffer, such as a flight recorder or an earthquake recorder. For these applications having recorded data before an event happens is desired. FRAM is particularly suitable for such applications since it can be rerecorded trillions of times.

The HSR node measures only 31×31×5 mm including mounting tabs and operates from a 3 volt DC supply. When logging data continuously at 50 kSPS, average current consumption was measured at 8.8 mA (26.4 mW). When actively transmitting digital data from non-volatile memory (along with framing and checksum bytes), the average current consumption was 25 mA (75 mW). When in sleep mode, current consumption was only 20 microamperes (0.060 mW). To test performance, a signal generator was used to produce a 1 kHz sine wave input (reference) signal, and this reference waveform was sampled using the HSR node's single ended input.

In one embodiment, the instrumented axial load sensor bolts are very similar to Microstrain's shear bolt sensor, as described in the '111 application. However, whereas the shear bolt strain gages of the '111 application are located and oriented to measure shear load, for connecting wind turbine blades 30 to hub 36 the primary load is axial tension. Because bolts 32 project through clearance holes 38 in hub 36 the shear load in bolts 32 is theoretically zero. In some cases, however, there is contact between bolt 32 and the inner bore of hub clearance hole 38, and some shear load may be introduced in bolt 32. But this shear load does not enter into the equations for calculating the two moments.

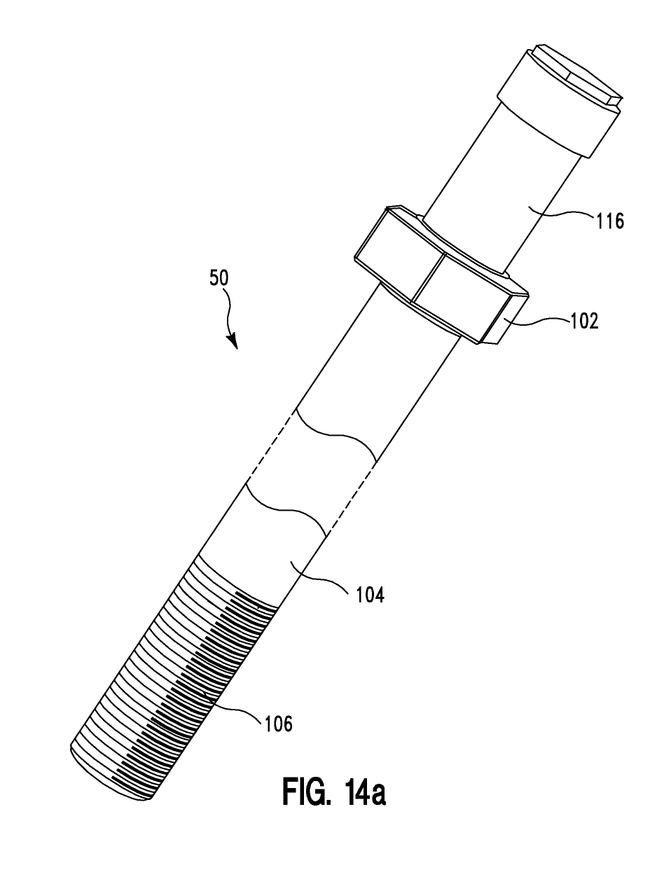

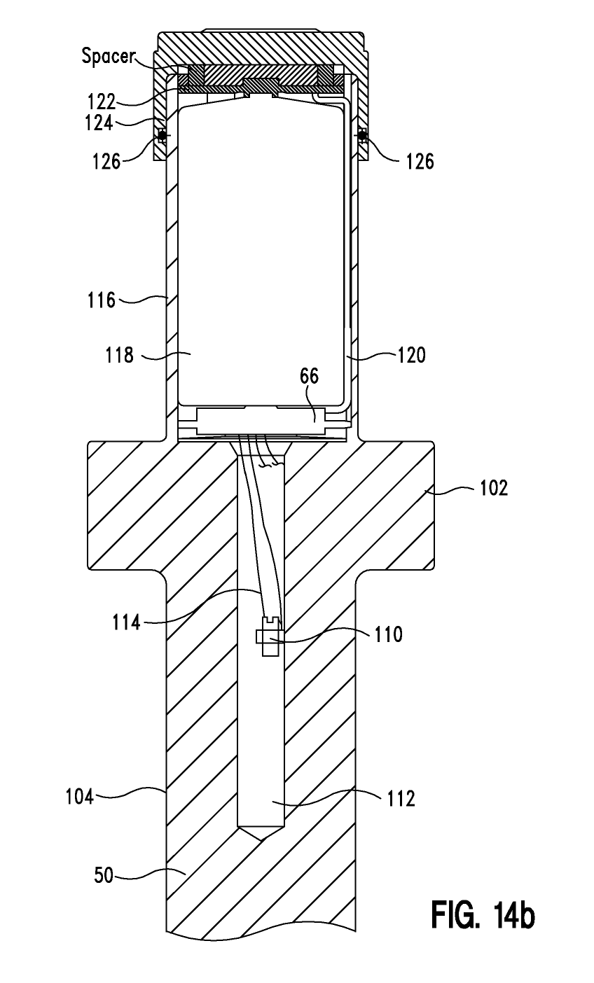

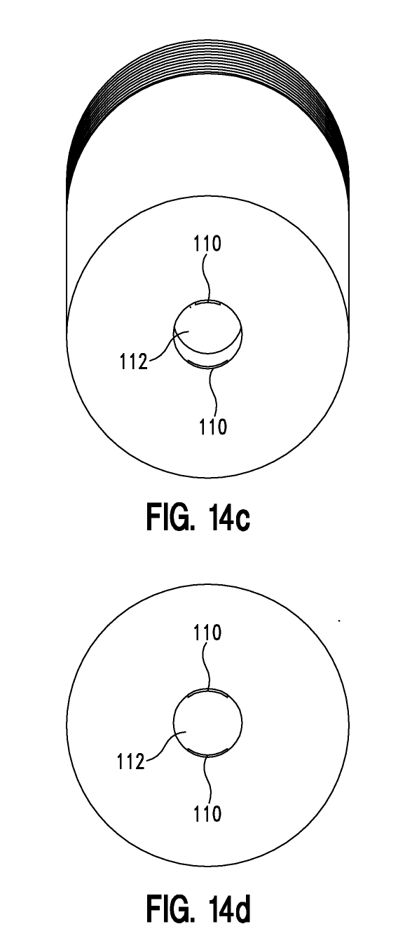

Therefore, in this embodiment, strain gauges 110 are oriented along the bolt/bolt axis to measure the axial load, as shown in FIGS. 14a-14d. Instrumented axial load sensor bolt 50 includes bolt head 102, bolt pin portion 104, and threaded section 106. Instrumented axial load sensor bolt 50 also includes bore hole 112 instrumented with four strain gauges 110 oriented to be sensitive to tensile and compressive loads along the bolt axis while canceling shear, bending, torsion, and thermal effects. Wires 114 connect the strain gauges to first printed circuit board 66 located in instrumentation housing 116 of instrumented axial load-sensor bolt 50. Of the four wires two are shown. First printed circuit board 66 includes the sensor node 64 components in the block diagram of FIG. 12a. Power is provided to components on printed circuit board 66 with Tadiran D-cell battery 118, part number SL-2780, 19 amp-hr capacity. Wire 120 connects from transceiver 88 located on first printed circuit board 66 to antenna printed circuit board 122 located at one end of housing 116 adjacent cap 122. Cap 124 is made of a material through which radio can penetrate, such as acetyl or Delrin. O-ring 126 provides a seal for cap 124

The present inventors recognized that by using FRAM for non-volatile memory and by changing their A/D converter to one such as the Texas Instruments ADS8319 they could enhance the sampling rate significantly, at least to 50 ksamples/S.

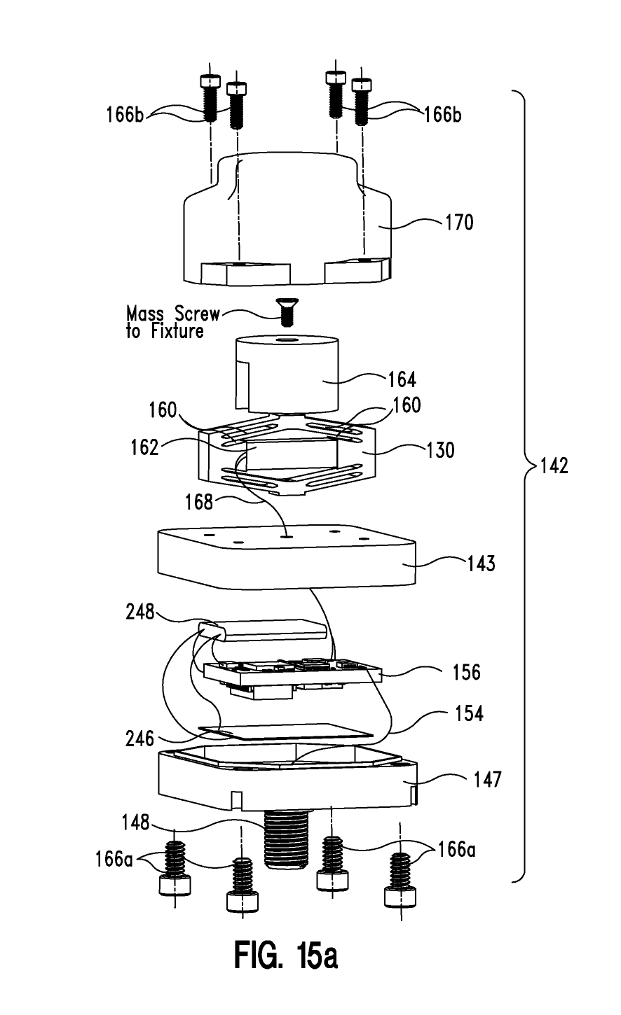

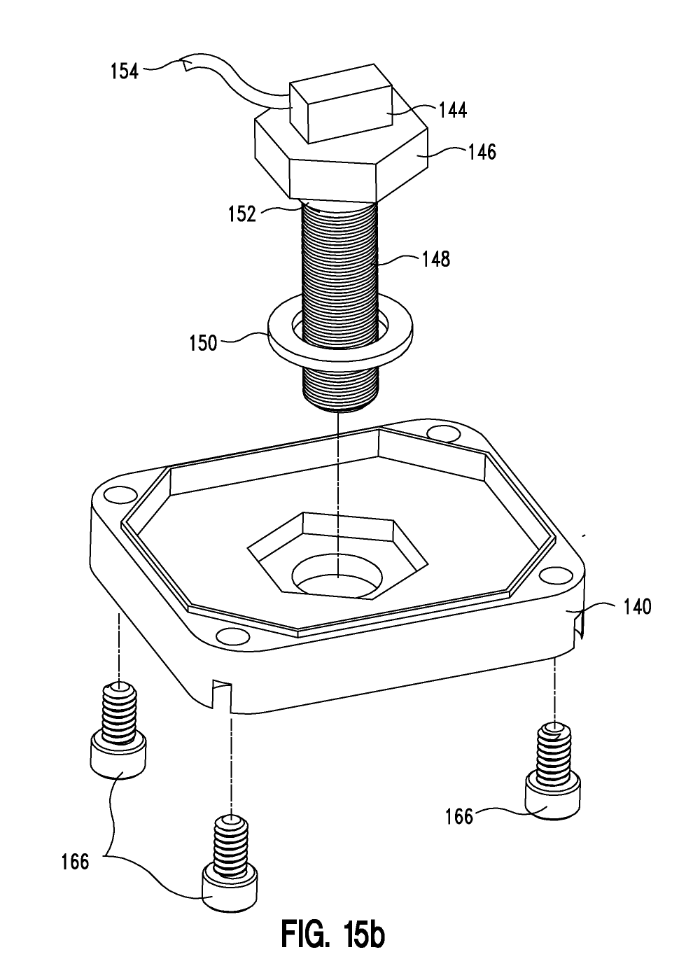

In one embodiment sensor node 64 is independently powered with long life batteries, as shown in FIG. 14b. Sensor node 64 can also be provided with an energy harvesting device, alternatives of which are shown in FIGS. 15a-15b, 16a-16b, and 18a-18b. Bolts 32 for wind turbine blades 30 live in a low rpm rotating environment (10 to 20 rpm max) which facilitates self-powering through energy harvesting. The vibrations experienced by bolts 32 as the turbine rotates in the wind can be used to resonate flexure element 130 and mass 134 to generate energy, as shown in FIGS. 15a, 16b, and FIG. 18b.

Various embodiments of flexures 130 are described herein. Each of the types of flexures can be made from a material such as superelastic NiTi (nickel titanium) to allow for large strains without damage. To adjust the resonant frequency up or down the flexure can be made thicker or thinner. Each of the flexures can have stops to protect it from overloads.

In one embodiment, flexure 130 is a cantilever beam energy harvesting device, as described in the '117 application, mounted on a vibrating surface. In another embodiment base 140 of energy harvesting device 142 of FIG. 15a-15b is mounted on a vibrating surface, such as a gear box within the wind turbine or within instrumented axial load-sensor bolt 50 to replace large Tadiran D cell battery 118 of FIG. 14b. Vibration is transmitted up through base 140 into diamond-shaped flexure 130 which vibrates. Accelerometer 144 is located on top of head 146 of mounting bolt 148 extending down through base cover 147 into the gear box receptacle, as shown in FIG. 15b. Vibrations of energy harvesting device 142 are isolated from accelerometer 144 by elastomeric vibration isolator gasket 150 in compression. Shoulder 152 on mounting bolt 148 is used to prevent excess compression of elastomeric vibration isolator gasket 150, as also shown in FIG. 15b. Thus, accelerometer 144 is isolated from the resonant vibrations of flexure element 130 of energy harvesting device 142 and can accurately measure vibrations of the gear box. Accelerometer 144 can be Model 52 from Measurement Specialties, Inc., Hampton, Va. Through PCB to accelerometer wires 154 accelerometer 144 is connected to PCB 156 of FIG. 15a that includes the elements shown for each wireless vibration sensing node 64 shown in FIGS. 12a-12c, 13, and 19.

In certain wind conditions the wind turbine can start to shake or oscillate at an amplitude that can cause damaging strains to its structural elements. The wireless accelerometer sensing node shown in FIG. 12c can monitor for this high amplitude shaking condition and send an alarm signal to the data aggregator which sends a signal to the pitch controller to adjust pitch of the blades, for example, toward more orthogonal to the rotation plane of the blades. If the pitch controller includes its own wireless interface, the wireless accelerometer sensing node can send its alarm signal directly to the pitch controller. In one embodiment of data processing, the microprocessor integrates accelerometer data twice to calculate displacement, and if the displacement exceeds a threshold, the transceiver sends the alarm signal.

The piezoelectric material and rectifier/energy management circuit with energy storage that is part of the wireless bolt tension and compressing sensing circuit or that is part of the wireless vibration sensing node provides power for operating the sensor and its electronic support circuit, including its transceiver.

With any of the energy harvesting devices, the mass, dimensions and stiffness of the flexure are selected so the natural frequency of vibration of the flexure is tuned to the predominant frequency produced by the wind turbine surface to which it is mounted. Stiffness in the embodiment of FIG. 15a may be adjusted by changing the dimension of slots 160 in flexure 130, with wider slots reducing stiffness. A residual compressive stress is provided for PZT stack 162 so the PZT is always in compression.

For installation, flexure 130 is compressed, opening the space between the ends where PZT stack 162 will be installed. Then when PZT stack 162 is installed and the pressure is released, PZT stack 162 is held under a residual compressive stress. During installation, PZT stack 162 is bonded at only one end so PZT stack 162 is protected from overloading while mass 164 is vibrating. Glue, such as Loctite, is provided on base screws 166a and housing screws 166b to keep them from loosening while flexure 130 is vibrating.

The structure of FIG. 15a provides a mechanical disadvantage to provide amplified cyclic compressive and tensile strains in the layers of piezoelectric material of stack 162 provided by a relatively small amplitude of vibration. The geometry of flexure 130 provides force amplification because PZT stack 162 is at a mechanical disadvantage. Thus, this compact system can generate more energy than would be available from vibration of mass 164 by itself directly on the PZT. This periodic high strain provided to stack 162 of piezoelectric material provides a high output ac voltage at leads 168. Housing 170 provides protection for energy harvesting device 142. Such a structure was tested under conditions replicating those of a helicopter gearbox and provided 37 mW of power at 1445 Hz, providing a rectified voltage of 4.7 Volts.

In one test, energy harvesting device 142 was excited by vibrations that reproduced those measured from a helicopter main gear box. For the test, output of energy harvesting device 142 was collected in a capacitive energy storage circuit, and “consumed” by a fixed load resistor. The absolute and normalized power output values for energy harvesting device 142 are shown in Tables I and II. These data provide a guide to design of the harvester for a given high sample rate vibration monitoring application, given the power consumption specifications as provided in the previous section. For example, assuming a vibration harvester of 4.3 cubic centimeters (cc) and 38.5 grams is suitable for the application, we can expect this harvester to generate 37 milliwatts continuously when mounted on this particular Helicopter Gear Box.

The duty cycle of sensing node 64 can be adjusted, or the harvester can be re-sized, to meet the needs of the particular monitoring application. The output of our vibration harvesters increases approximately linearly with both mass and volume. The power consumed by the sensor node decreases significantly as the interval between samples is increased. The calculated average power consumption of our wireless sensor nodes 64 for a range of sample intervals are provided in the next section.

TABLE I
Absolute Energy Harvester Power Output, Helicopter Main Gear Box.

| Load | Rectified Output | Power Output |
|---|---|---|
| Resistor (Ohms) | Voltage (VDC) | (mW) |
| 600 | 4.7 | 37 |

TABLE II
Normalized Energy Harvester Power Output, Helicopter Main
Gear Box.

| | | Power | Specific |
|---|---|---|---|
| | Volume | Density | Power |
| Mass (grams) | (cc) | (mW/cc) | (mW/kg) |
| 38.50 | 4.30 | 8.60 | 961 |

High Sample Rate Energy Consumption w/Duty Cycling

A high sample rate node with an accelerometer is particularly useful for the detecting problems in the gear box of the wind turbine where a gear or output shaft is spinning at a high rate or is subject to high frequency vibration. The high sample rate node can also be energy harvesting, as shown in FIG. 12c.

The high sample rate node, as well as the other nodes in the network, will support scheduled data logging according to programmable time intervals (duty cycles), along with periodic RF transmission. Shorter duration sampling duty cycles will result in longer sleep durations, as well as reduced “on” time for radio transmissions. Therefore, periodic time interval sampling or “duty cycling” can greatly reduce the average power consumption, as we illustrate in the following example.

In this example, 50 kSPS data are collected for a relatively short (1 second) duration, or “burst”, at a time interval of once per minute (60 seconds). The time duration required for wireless data transmission can be calculated by dividing the number of samples recorded by the wireless data transmission rate. Digital wireless data transmission, using an efficient 802.15.4 protocol with framing and error checking, can be accomplished at a rate of 4000 SPS. This information, along with power consumption for various operational modes, allows the average power consumption to be calculated by the following expression:

Average power consumed=(data logging duty cycle)*(power consumed when logging)+(wireless data transmission duty cycle)*(power consumed when transmitting)+(sleep duty cycle)*(power consumed when sleeping).

Where the power consumed when logging=26.4 mW; transmitting=75.0 mW; and when sleeping=0.060 mW. And where the data logging duty cycle=1 sec/60 sec=1.67%; the wireless data transmission duty cycle=12.5 sec/60 sec=20.83%; and the sleep duty cycle=77.5%.

Therefore, the average power consumed=1.67%*26.4+20.83%*75 mW+77.5%*0.060 mW=16.1 mW. This power consumption is ˜44% of the gearbox vibration harvester's output (37 mW). Therefore, sampling at 50 kSPS rates for 1 second every minute can be perpetually sustained, without primary batteries, in the gearbox application. Rechargeable batteries are used to store energy from the harvester.

Our system was designed to be fully programmable, and therefore, fully adaptable to the needs of specific vibration monitoring applications. In Table III below, we provide the average power consumption (in mW) for 50 kSPS data collected for 0.1 sec, 0.5 sec, and 1 second durations at time intervals of once per minute, once per 10 minutes, once per hour, and once per day. Longer time intervals between data acquisition bursts would allow smaller, lower mass energy harvesters to sustain operation.

TABLE III
Average power consumption (mW) for 50 kHz data acquisition
at various time intervals & durations
Acquisition Interval

| Sample | | | | |
|---|---|---|---|---|
| duration (sec) | 1 min | 10 min | 1 hour | 1 day |
| 0.1 | 1.67 | 0.22 | 0.09 | 0.06 |
| 0.5 | 8.09 | 0.86 | 0.19 | 0.07 |
| 1.0 | 16.1 | 1.66 | 0.33 | 0.07 |

Thus, energy requirements from a battery or energy harvester are reduced with shorter sample duration and longer acquisition time intervals between sampling. Because the nodes have a real time clock, data obtained from the vibration monitoring nodes on the gear boxes is time stamped with a clock synchronized with clocks on the smart bolts and so the data for each can be correlated.

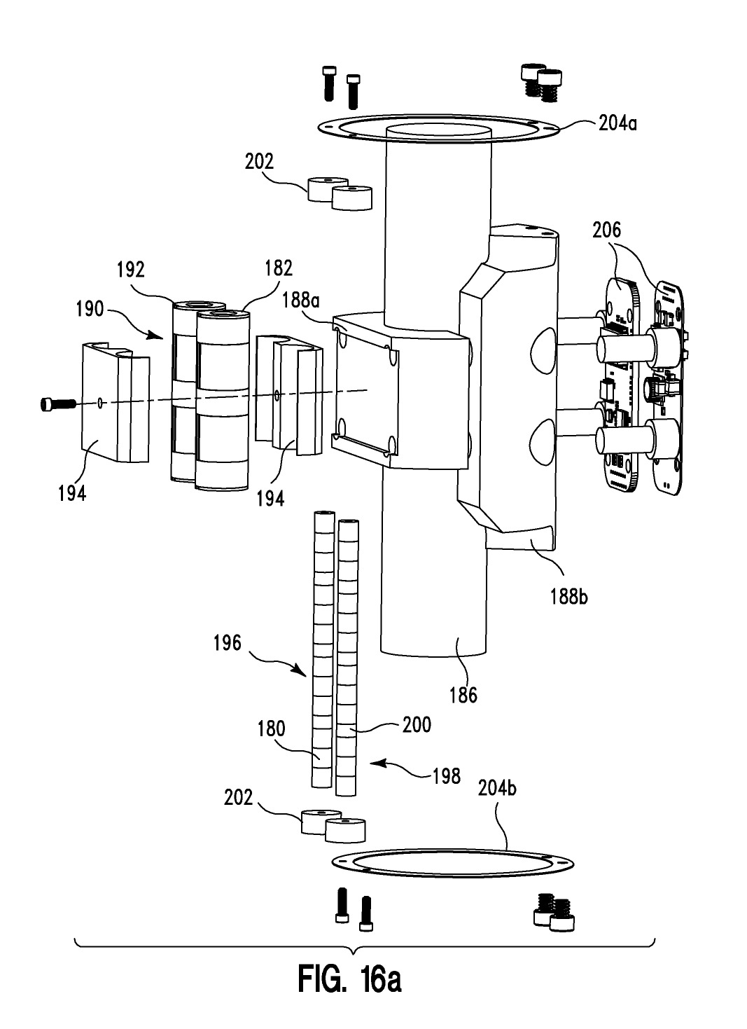

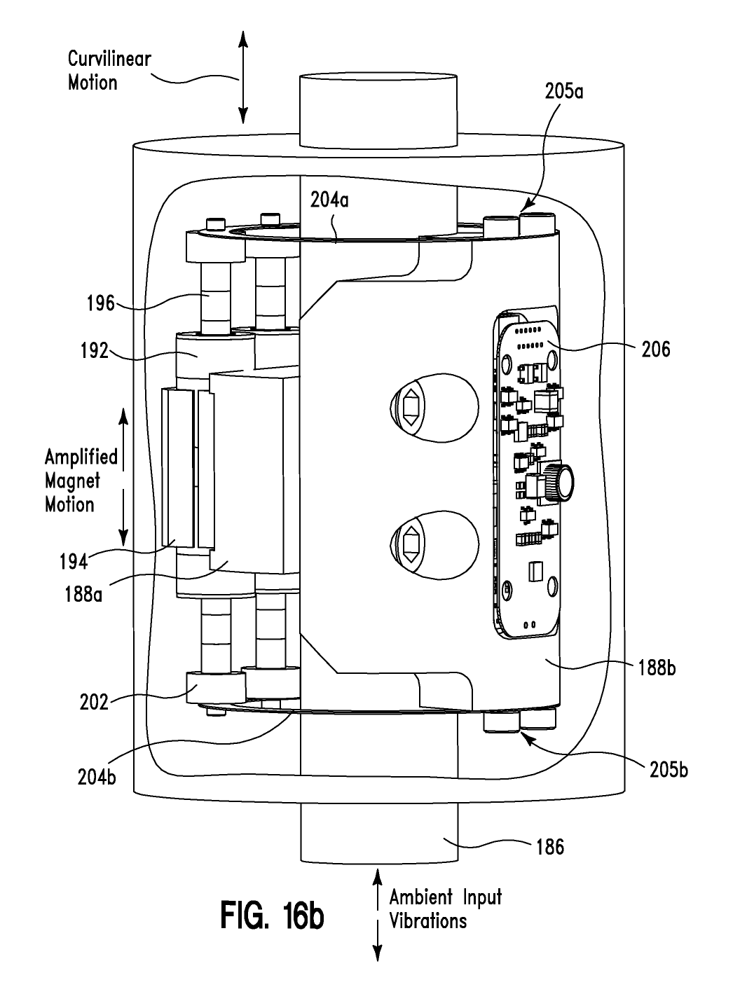

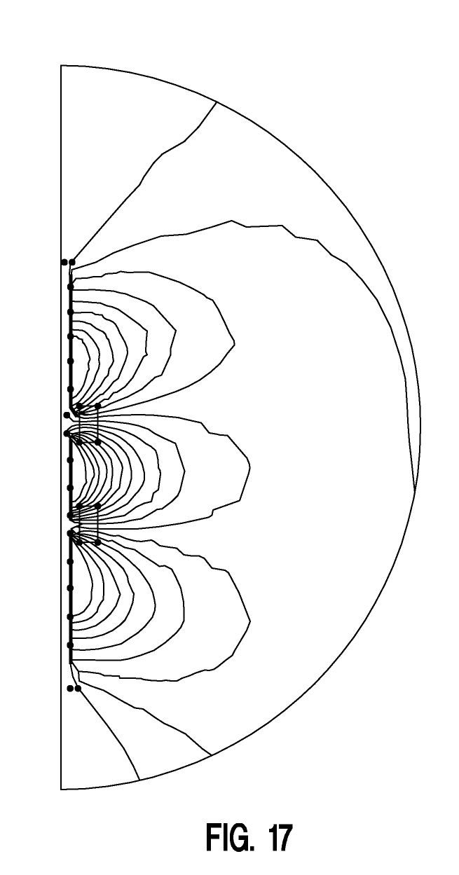

In another embodiment, piezoelectric material is replaced with one or more magnets 180 vibrating inside one or more coils 182, as shown in FIGS. 16a-16b. Energy harvesting device 184 mounted to vibrating structural element 186, such as a helicopter pitch link or a bolt on a wind turbine, includes front and rear post clamps 188a, 188b. It could also be mounted to another type of vibrating object.

Several separated coils 182 are wound around each bobbin 190 with coil winding directions alternating clockwise and counterclockwise. In this embodiment three such coils 182 are included. Two bobbin and coil assemblies 192 are clamped to front clamp 188a with coil clamps 194.

Passing through each bobbin 190 is a stack 196 of permanent magnets 180 arranged with multiple oppositely directed magnetic fields to induce current in each of oppositely wound coil 182. One embodiment, illustrated in FIG. 16a shows 3 NdFeB magnets 180 in each magnetic section 198 of stack 196, and the magnetic sections 198 are separated by non-ferromagnetic material 200, such as copper or brass. Magnetic sections 198 are oppositely oriented, for example the top three magnets 180 each oriented with north pole up and then the next three magnets 180 below copper spacer 200 are oriented with south pole up. Thus, the example of FIG. 16a shows three copper spacers 200 and three regions of high fields in the vicinity of three spacers 200 from the opposing magnetic fields at spacers 200. Thus, substantial current will be generated in three coils 182 as magnet stack 196 vibrates.

Tuning weights 202 are provided with each stack of magnets 196, and magnet stacks 196, tuning weights 202, and copper spacers 200 are all mounted to two circular spring elements 204a, 204b connected to the rear post clamp 188b. Circular spring elements 204a, 204b form a linkage that constrains stack of magnets 196 to move in curvilinear fashion up and down within bobbin and coil assembly 192, preventing binding. As rear post clamp 188b vibrates with post 186 to which it is mounted, spring element 204a, 204b also vibrates, and vibration amplitude increases with the distance from the pivot point 205a, 205b at rear post clamp 188b, the maximum amplitude directly across from the pivot point. If tuning masses 202 are adjusted so that spring 204a, 204b vibrates in resonance with the frequency of vibration of post 186, amplitude of vibration will be large and a substantial amount of electricity will be harvested at coils 182 and brought along wires (not shown) to power conditioning and signal conditioning boards 206.

The magnetic induction energy harvesters of FIGS. 16a, 16b use the principle of Faraday's Law to generate an induced current in an electrical coil by oscillating a magnet within that coil. Faraday's Law equates the electromotive force in the coil with the time rate of change of the magnetic flux though the coil.

E=−dφ_{B}/dt

By taking minor input vibrations and amplifying those vibrations via a resonant-tuned mass-spring system, we create the desired large magnet oscillations with the coils. Our specific magnet arrangement is configured with two specific parameters in mind: (1) Non-ferrous spacer 200 is sized to specific dimensions to optimize the rate of flux change in coil 182 as magnet 180 passes though, thereby optimizing the current and power induced. This size is determined via computer modeling of the magnetic interactions; and (2) repelling magnets are placed within coil 182. The opposing polarity concentrates the flux lines thereby increasing the rate of flux change as magnets 180 oscillate. This configuration allows even minor oscillations to produce significant current.

Magnetic flux lines imaging the magnetic field produced by opposing magnets 180 inside coils 182 from FEA software are shown in FIG. 17.

The prototype built by applicants used 0.012″ thick stainless steel spring elements 204a, 204b with an OD of 2.3″ and an ID of 1.9″. The prototype used bobbins 190 with 2 coils 180 each (therefore 3 magnet arrays 198 on each stack 196). Coils of various wire gauges (32-48) were tested with an ID of 0.25″, an ID of 0.5″ and a length of 0.25″. As the wire gauge was decreased (wire diameter increased) the output voltage decreased while power remained constant. Magnets 180 used in the prototype were N50 (NdFeB), 0.1875″OD, 0.063″ID, x 0.1875″ long. Tuning weights 202 were adjusted such that the vibrating mass, including magnets 180, weights 202, spacers 200, and springs 204a, 204b was 22 grams. This resulted in a resonant frequency of approximately 22 Hz. Input vibrations for these tests ranged from 0.1 g to 1.0 g and the energy produced ranged from 3.5 mW to 35 mW respectively.

Mechanical stops could be included to protect springs 204a, 204b against overtravel and premature failure. These stops could be magnetic (opposing the last set of magnets) to create a damper effect as opposed to a hard stop.

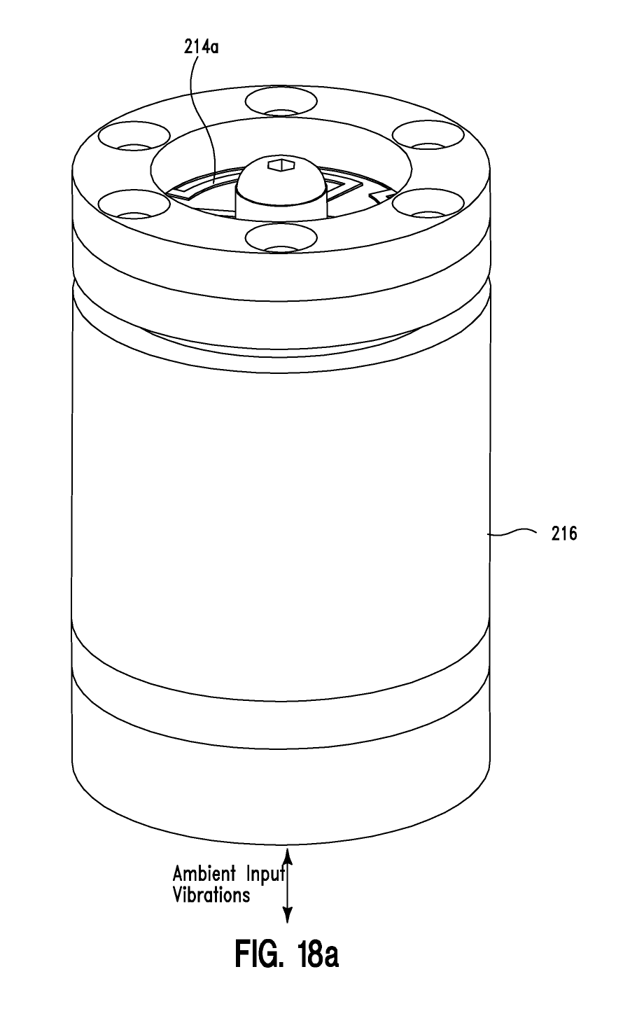

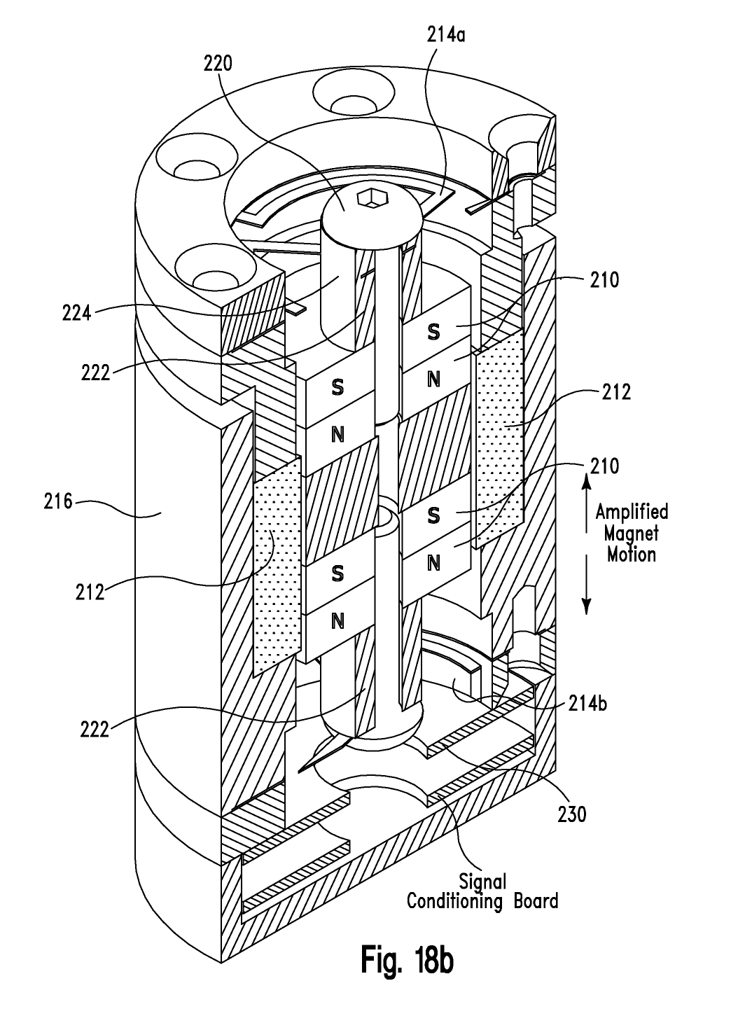

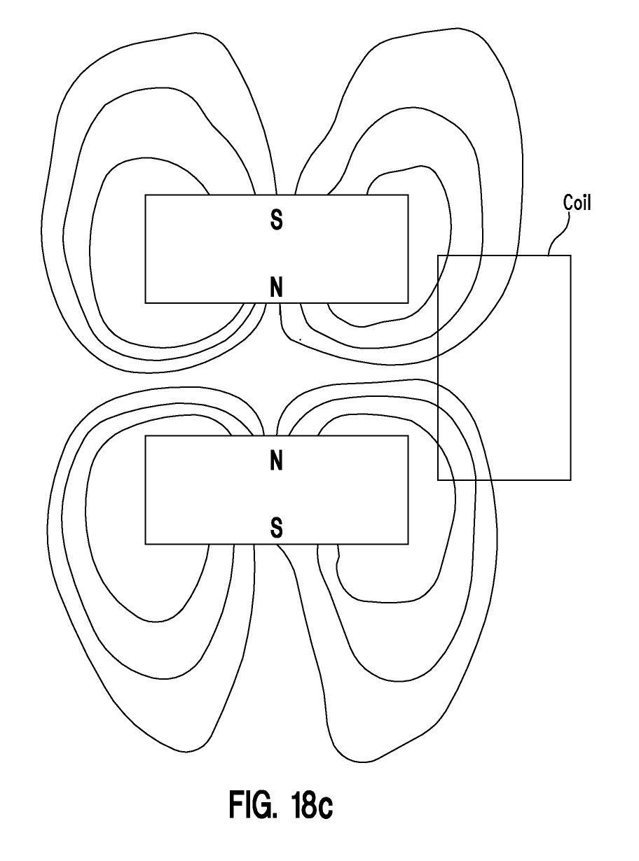

In another embodiment with one or more magnets 210 moving in coil 212, flexure element 214 is internal to housing 216, as shown in FIGS. 18a-18b, and magnets 210 move within coils 212 concentric with flexure element 214a, 214b. This embodiment can be used to provide an energy harvesting device that has a form factor similar to that of an ordinary battery, such as a D cell. In this embodiment, screws 220 force the same poles of magnets toward each other and against brass spacer 222. With same poles facing each other magnetic flux between the magnets and at the coil is much stronger, as shown in FIG. 18c. As the assembly of screws 220, tuning weights 224, magnets 210, and brass spacer 222 moves up and down with vibration, a current is induced in energy harvesting coil 212 adjacent brass spacer 222. Power conditioning board 230 includes a thin film battery and a super capacitor for storing energy. Top and bottom flexure elements 214a, 214b constrain movement primarily in a vertical fashion.

### Energy Harvesting Circuit

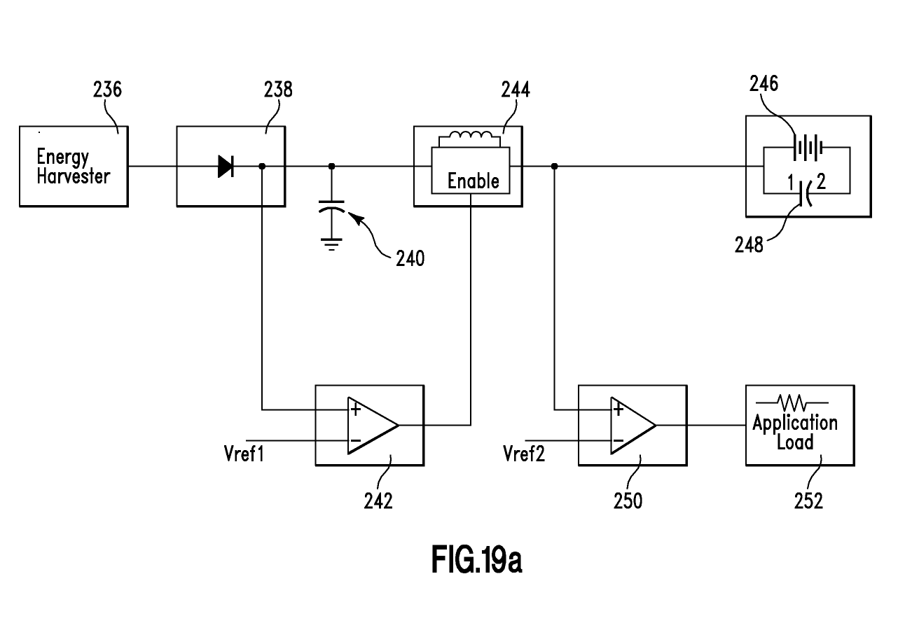

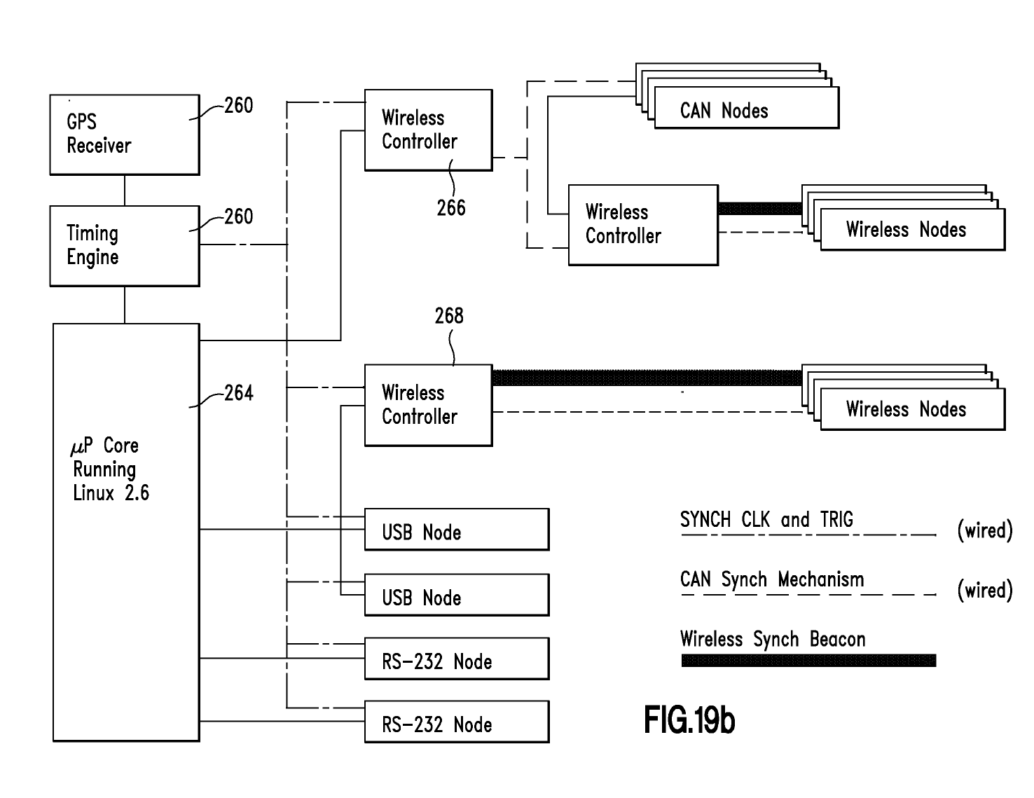

AC voltage produced from energy harvesting element 236 is rectified by rectifier 238 and stored in a large capacity storage element, such as input storage capacitor 240, as shown in block diagram of FIG. 19a. Once the voltage on input storage capacitor 240 reaches a predefined level set by vref1 in comparator/voltage sensitive switch 242, such as 8 volts, comparator/voltage sensitive switch 242 turns on step down (buck) DC-DC converter 244 which transforms the high voltage stored on input storage capacitor 240 to a voltage that is required to charge lithium thin film battery (TFB) 246. A typical charge voltage is 4.2 V.

Supercapacitor 248 is included in parallel with TFB 246 to provide high peak current capability. Applicants found that TFB's 246 internal series impedance increases as temperature decreases, and this high impedance limits the peak instantaneous current. They found that using supercapacitor 248 in parallel with TFB 246 mitigates this issue. Thin film battery 246 can be part number MEC07, IPS Inc., Littleton, Colo. Supercapacitor 248 can be HW207, CAP0xx, Ltd, Myrtle Beach, S.C. Buck converter 244 can be part number LT1934-1 from Linear Technology, Milpitas, Calif.

As long as TFB 246 is adequately charged battery undervoltage/lockout switch 250 provides power to the application load. If TFB 246 is discharged below a critical level, such as 2 V, application load 252 is disconnected from TFB 246 until it is charged. Voltage sensitive switch 242 and battery undervoltage lockout switch 250 can both be part number LTC1540 from Linear Technology.

### Data Aggregation

The wireless sensor data aggregator is responsible for time synchronized data collection from wireless and hard wired networks. Important design criteria for the WSDA were:
Open architecture operating system
Provides time synchronization platform
Data saved in scalable sensor database, supporting flexible data types, sample rates, data base queries, and sorts
Multiple bus interfaces supported:
Multiple bus interfaces supported:
IEEE802.15.4 (wireless)
Ethernet
RS232/RS422 (wired)
USB
1553B serial bus (digital, wired)
CAN

### Data Synchronization

One of the challenges for a distributed multi-network topology is synchronizing all the data acquisition nodes throughout the entire system. FIG. 19b provides a block diagram of WSDA 96 and timing control for its associated hard-wired and wireless sensor nodes, such as sensor node 64. WSDA 96 functional blocks include GPS receiver 260, timing engine 262, microprocessor (uP) core 264 running Linux 2.6, CAN bus controller 266, and wireless controller 268. WSDA 96 and wireless sensor nodes feature precision, nanopower, temperature compensated timing engine 262, or real time clock (RTC) 78 which uses an onboard temperature sensor, calibrated look-up tables, and an oscillator tuning mechanism to maintain a highly accurate frequency of +/−3 parts per million (PPM) over an operating temperature range of −40 to +85 deg C.

The real time clocks 78 on all wireless and wired sensor nodes 64 are synchronized at the beginning of a test to the WSDA base station's time reference, using a wired beacon and a wireless beacon to communicate that reference. The WSDA base station uses a Global Positioning System (GPS) 1 pulse per second (PPS) clock as the default timing reference. In the event that GPS is not available, the WSDA switches to its internal +/−3 PPM real time clock as the timing reference to insure synchronization of all the remote sensor nodes to the WSDA's clock. With either timing source, the WSDA's timing engine provides a stable 1 Hz reference for the transmitted synchronization beacon.

On wireless sensor nodes 64, the same timing engine is slightly modified to provide the real time clock to provide adjustable output from 1 Hz to 4096 Hz, which is used to drive a sensor-sampling interrupt on the host processor.

Precise timing enables the aggregated data from the network to be accurately time stamped, but it also enables scaling of the wireless network. Combining time division multiple access (TDMA), carrier sense multiple access (CSMA), and frequency division multiple access (FDMA), the synchronized network can support a large number of wireless sensor nodes. The system's aggregate sensor sampling rate with continuous digital wireless communications may be estimated at 10,000 samples/sec per radio channel (at up to 16-bit sensor data resolution). For example, assuming a network of wireless strain nodes were configured to sample a 3-axis strain gauge rosette at a rate of 33 samples per second, this system will support up to 100 distinct wireless nodes (300 strain gauges) using only TDMA and CSMA techniques on a single radio communication channel. By adding radio transceiver chips, or by scanning radio channels within the WSDA base station, the system will theoretically support 16 of these strain sensing networks, or as many as 300 strain gauges*16 radio channels=4,800 individual strain gauges.

### Turbine Blade Pitch Control

The results of the load sensor measurements are ultimately sent to the pitch control system, which in one embodiment is located inside nacelle 270 of wind turbine 37, i.e. on a non-rotating part of wind turbine 37.

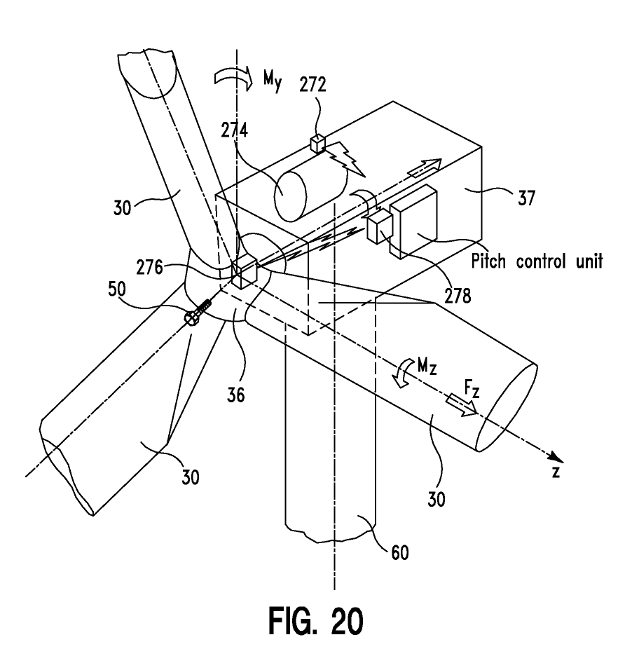

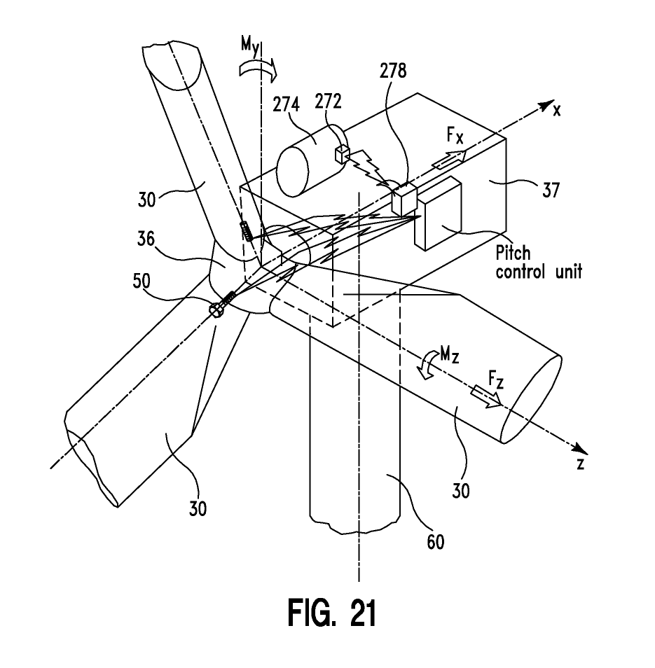

a) In one embodiment, each sensor, such as strain sensors, accelerometers, and temperature sensors in instrumented axial load-sensor bolt 50, or gearbox sensors 272 in gearbox 274, are connected to a wireless transceiver. The data from each sensor is wirelessly transmitted to a transceiver (not shown) in hub data collection unit 276 in rotating hub 36. From hub data collection unit 276 in rotating hub 36 the data is transmitted to WSDA box 278 inside stationary nacelle 37, as shown in FIG. 20. This avoids problems associated with transmission in a metal box.
b) In another embodiment, each sensor is connected by wire to hub data collection unit 272 that has both wired and wireless transceiver capability in rotating hub 36. From rotating hub data collection unit 276 the data is then wirelessly transmitted to WSDA box 278 in stationary nacelle 37. A CAN bus or an RS485 network can be used for wired transmission from sensors to hub data collection unit 276, minimizing the amount of wire used. FIG. 20 shows wireless connections to the hub data collection unit but these can be wired as described herein.
c) In another embodiment, each sensor is connected to a wireless transceiver and the data from each sensor is wirelessly transmitted directly to WSDA box 278 in stationary nacelle 37, as shown in FIG. 21.

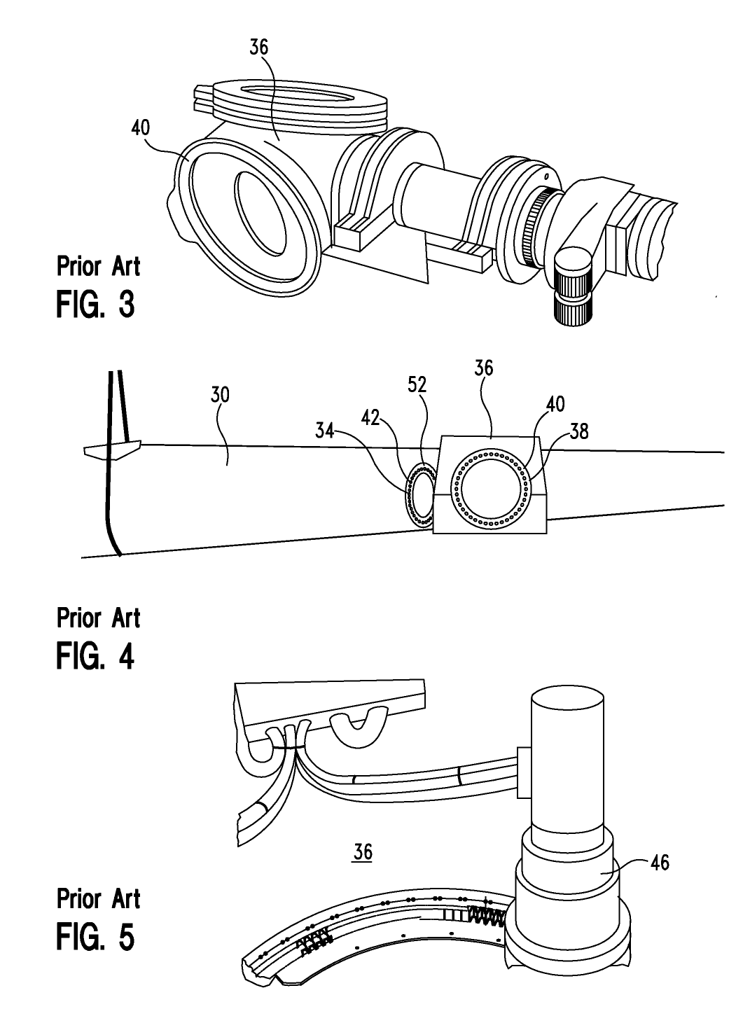

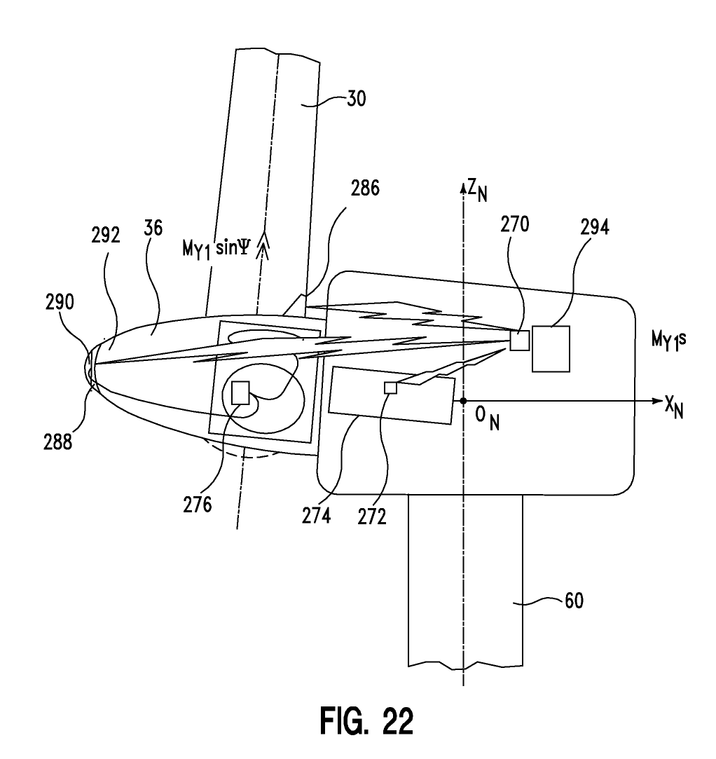

One of the technical challenges that affects this choice is that the transmit antennae of load sensors in bolts 50 are located within metallic hub 36. Hub 36, shown in FIG. 3, is a large steel forging that may act as a shield for transmission of RF signals. Another embodiment, shown in FIG. 22 may be a more effective communications scheme because it uses only one antenna 286, and antenna 286 is located outside hub 36. Alternatively antenna 288 is located near fiberglass portion 290 of hub fairing 292 to communicate with pitch control unit 294 in nacelle 37, as also shown in FIG. 22.

### Alternate Bolt Load Sensors

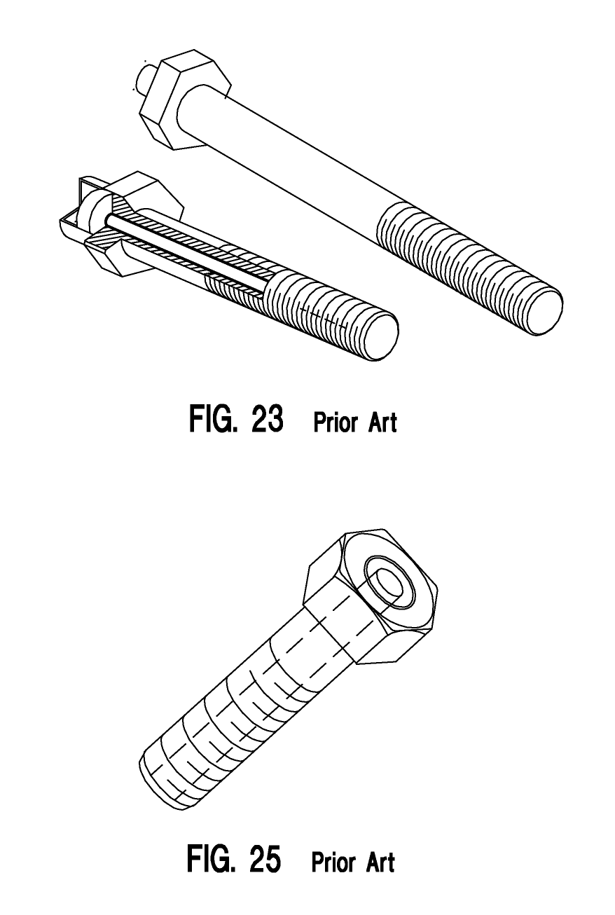

In addition to the strain gage method for instrumented sensing bolt loads as described herein above, alternate instrumented sensing bolts can be used. One approach marketed by Rotabolt (http://www.sound-connections.co.uk/rotabolt/index.html) is shown in FIG. 23, includes a precision bored bolt and a central sensing pin. A precisely controlled clearance or gap is located between the pin and the inner bore of the bolt when they are installed with no preload in the bolt. However, as tension load is applied to the bolt during tightening, it increases in length, and the ability of a cap on the exposed pin extremity to rotate freely is sensed by the installer's fingers, thereby providing an indication that the load on the bolt exceeds a threshold, and that the bolt was properly tightened.

In one embodiment applicants provide a sensor, such as an air gap capacitance sensor to provide an electrical signal indicating size of the gap between the normally freely spinning cap and the bolt head.

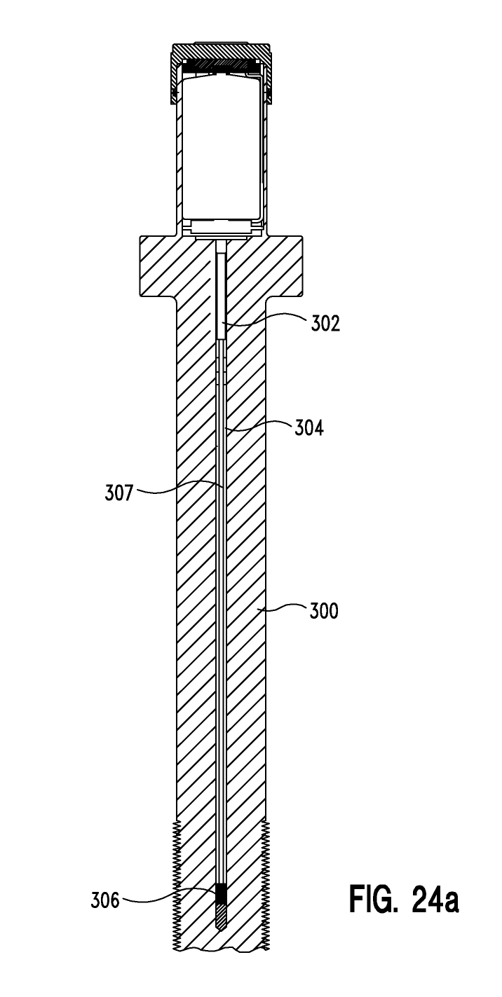

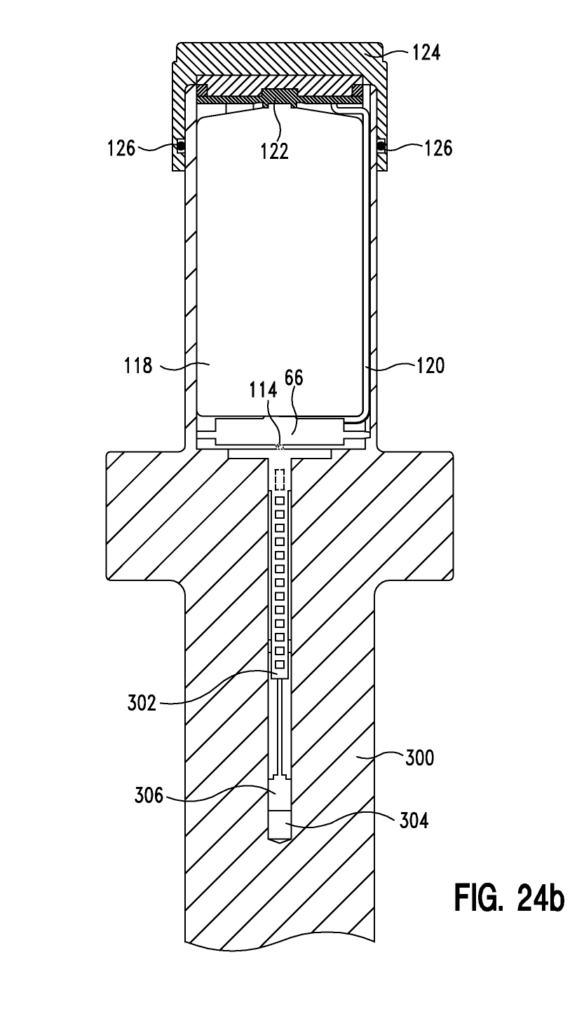

In another embodiment, applicants provide a sensor, such as a DVRT, to provide an electrical signal indicating the change in length of the bolt when the bolt is properly tightened. That change in length is related to strain and the amount of tension in sensing bolt 300, as shown in FIGS. 24a, 24b. In this embodiment, DVRT assembly 302 is included in bore 304 in sensing bolt 300. End 306 of core 307 of DVRT assembly 302 is bonded to an inside surface of bore 304. Body 308 of DVRT assembly 302 is also bonded to an inside surface of bore 304. Tension tightening sensing bolt 300 stretches bolt 300 and causes core 307 to move out of body 308, and this movement is sensed in coil 310 in body 308 of DVRT assembly 302. Movement of core 307 within coil 310 of DVRT 302 provided by strain of sensing bolt 300 is detected as changes to the reluctance of coil 310. Signals from coil 310 are provided to legs of Wheatstone bridge 70 on first printed circuit board 66, as shown in FIGS. 12a and 13, with portions of coil 310 providing inductive elements in bridge 70. Appropriate signal conditioning is provided as described in commonly assigned U.S. Pat. Nos. 5,914,593, 5,497,147, and 6,714,763, all of which are incorporated herein by reference.

Another bolt load sensing scheme is shown in FIG. 25 (from http://www.intellifast.de). In this case, the bolt head contains an ultrasonic transducer element. When the ultrasonic transducer element is powered with an electric pulse, it emits an ultrasonic pulse that travels down the length of the bolt, reflects off the opposite end (due to impedance mismatch), and is then sensed by the same transducer now acting as a sensor. Knowing the sound propagation velocity in the bolt material (typically steel), the total length of the bolt, l, can be calculated. As a tension or load is applied to the bolt, it experiences an increase in length.

$$d = \frac{Pl}{EA} where \qquad Eq . ( 11 )$$

d=Incremental displacement=l_{under load}−l_{no load}
P=Bolt load
l=Length of bolt under load
E=Youngs modulus of bolt material
A=Cross sectional area of the bolt

Therefore, the bolt load can be determined as

$$P = EA ( \frac{d}{l} ) \qquad Eq . ( 12 )$$

### Alternate Load Measurement Sensors

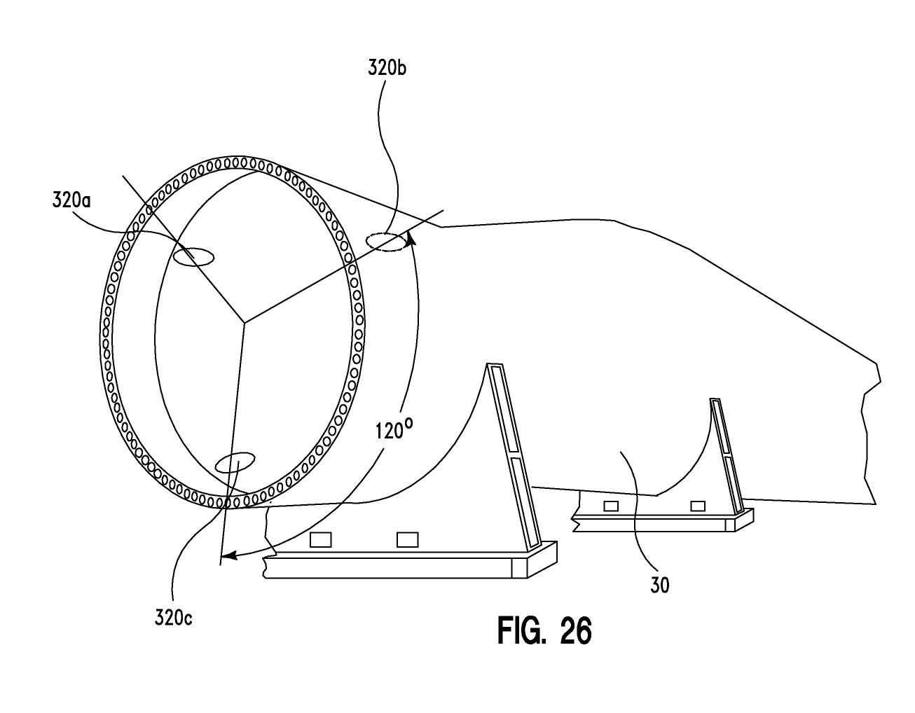

In another embodiment, strains on blades are monitored with strain gauges bonded to the blades, such as an interior surface of blades. In one embodiment, three strain gauges 320a, 320b, 320c are oriented within hollow blade 30 at 120 degree angles to each other, as shown in FIG. 26. A transfer function from strain measurements at the three positions within each blade 30 relating the strains to the loads experienced by each blade 30 is determined with a calibration procedure as described herein above. Multiple strain gauges, such as a biaxial rosette oriented at 90 degrees to one another, can be used at each location for temperature compensation and enhanced sensitivity. A triaxial rosette of strain gauges oriented at an angle with respect to each other can also be used at each of the three positions so that the principle strain magnitudes and directions can be determined. A temperature sensor (not shown) is included and this is used to provide for temperature compensation. For applications involving composite materials a higher range strain gauge than a conventional foil strain gauge can be use. An inductive type of strain gauge that uses an array of DVRTs was described in commonly assigned U.S. Pat. No. 5,497,147, incorporated herein by reference. A capacitive type of strain gauge can also be used. An interdigitated capacitive strain sensor device is described in European Patent Application EP 1113252 based on international patent application PCT/JP00/04538, filed Jul. 7, 2000, incorporated herein by reference. Another capacitive strain sensor is described in Design and Characterization of a Passive Wireless Strain Sensor, by Yi Jia, et al, Measurement Science and Technology Meas. Sci. Technol. 17 (2006) 2869-2876, Institute of Physics Publishing, incorporated herein by reference. The book, Capacitive Sensors: Design and Applications, by Larry K. Baxter, John Wiley and Sons, 1997, ISBN: 078035351X 9780780353510, incorporated herein by reference, also describes capacitive strain sensors.

In one embodiment, four sensors are used, placed at 12:00, 3:00, 6:00, and 9:00 o'clock, and this simplifies calculations because bending moments can be derived directly from measurements. The sensors at 12:00 and 6:00 are differenced to amplify flapwise bending and cancel temperature effects. Sensors at 3:00 and 9:00 are differenced to amplify edgewise bending. One problem is that there are huge temperature gradients on wind turbine blades and the material is not isotropic. In one embodiment, a secondary piece of material is used within each sensor to cancel temperature. Such strain gauges are available from Columbia Research Labs, Woodlyn, Pa. The present inventors recognized that to cancel readings by differencing 12:00 and 6:00 sensors, for example, advantage is provided by synchronizing them precisely or wiring them together.

A package as described in the '244 application, “Strain Gauge with Moisture Barrier and Self Testing Circuit,” can be used at each of the three positions in each blade. Precision timekeepers can be included in each package for time synchronization. A compliant bonding method can be used to conform the package to the curved shape of the blade.

### Wireless Data Transmission

In one embodiment, the wireless communication protocol is scalable and time-synchronized, facilitating correlating load data. In one embodiment, the communication protocol supports both wireless and hard-wired sensor networks. Data from different sensors are collected at multiple sampling rates and time stamped and aggregated within a single scalable database on a base station, such as a WSDA. The WSDA is connected to the pitch control unit. It can also be integrated with the pitch control unit. In one embodiment, the WSDA's processor supports a Linux server, web interface, eight (8) Gigabytes secure flash memory, CAN, IEEE 802.15.4, Ethernet, RS232/422, and mobile phone. In one embodiment the data is relayed over mobile phone networks to a secure server. Software permits access to the aggregated data over the internet, using the time stamp as a unifying reference for the various types of sensor information.

The WSDA, in addition to providing a central location for collecting wireless and wired network sensor data, also provided a beaconing capability to synchronize each sensor node's embedded precision timekeepers. For testing, a saw tooth analog voltage waveform was provided as an input to two wireless nodes to provide a reliable means of determination of the system's timing accuracy. With the synchronization beacon provided only at the start of a 2 hour long test, and with two wireless nodes exposed to multiple temperature cycles of −40 to +85 degrees C., the system demonstrated a 5 millisecond timing accuracy. Thus, for a wind turbine for which temperature changes more slowly, transmitting a beacon once every 20 minutes would result in a sub-millisecond timing accuracy.

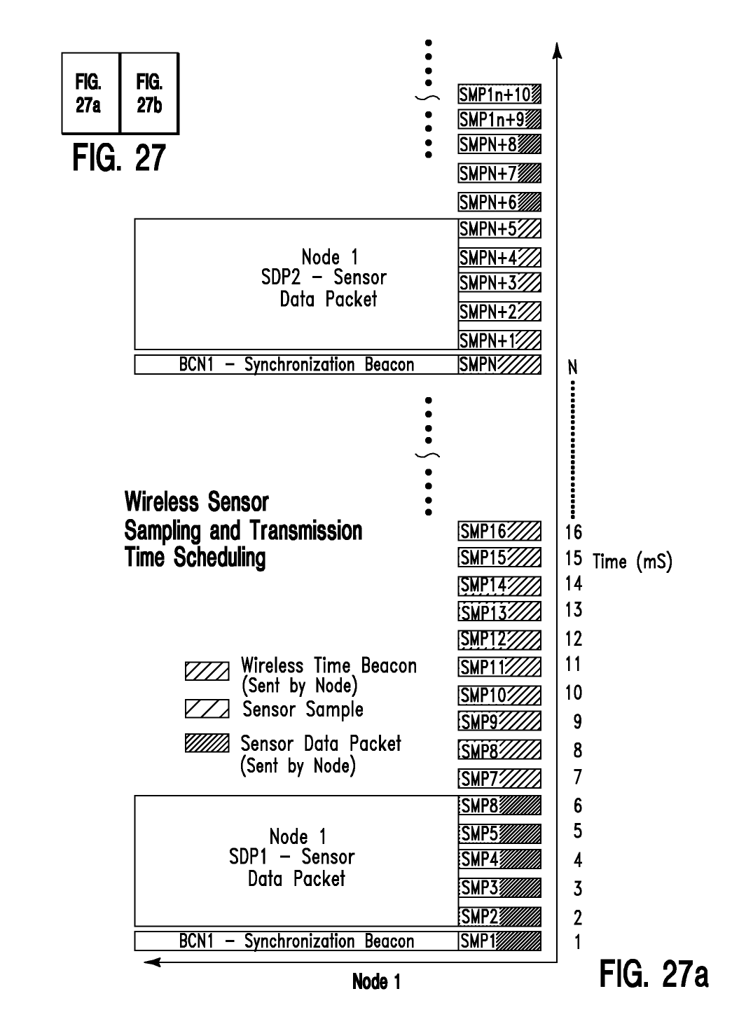

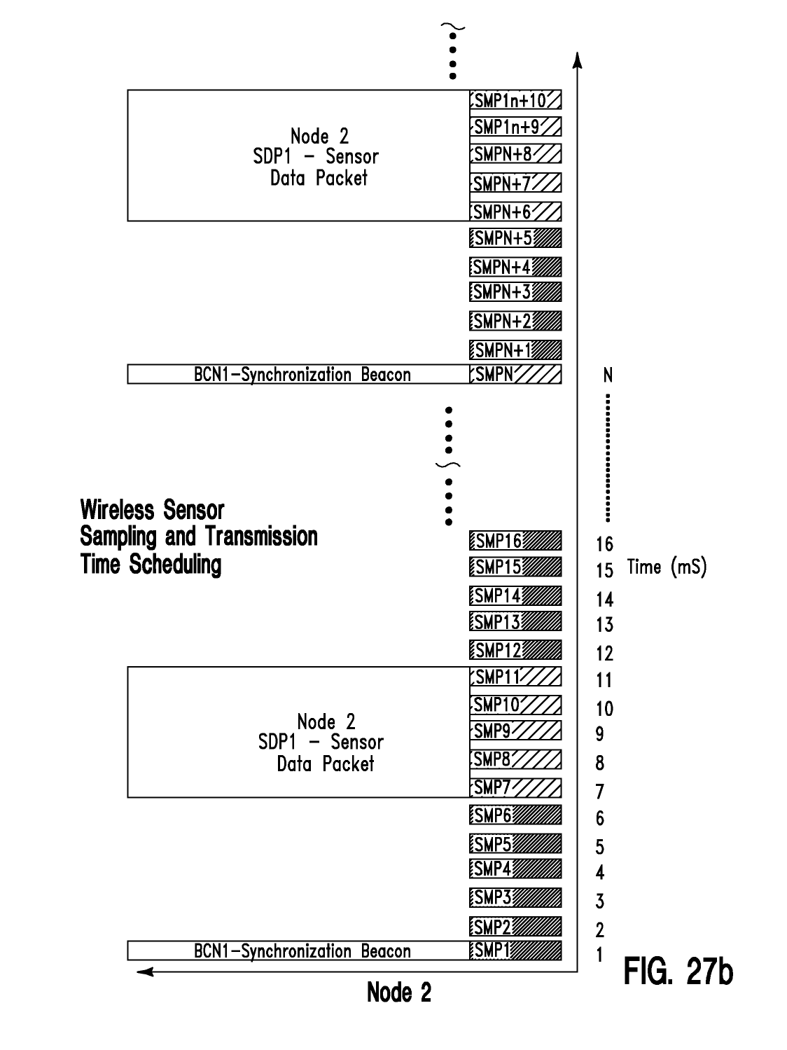

In one embodiment, a time beacon is provided from the base station or WSDA that reaches all sensor nodes simultaneously, as shown in FIG. 27, resetting and aligning the real time clock in each node with the beacon so all subsequent samplings of data are simultaneous, as also shown in FIG. 27. The beacon signal may be broadcast on a schedule, such as once per second. A longer or shorter time interval between beacons can be used. To save energy, receivers at each node turn on in time to receive that beacon and then turn off. Thus, receiver duty cycle can be substantially less than 1%.

While sampling of data from sensors is thus synchronized in all the sensors receiving the beacon, transmission from the nodes is staggered, as shown in FIG. 27, in order to prevent interference of transmissions. The time slots for transmission provided for each node are stored in a memory location on each node.

In one embodiment, 10 nodes are transmitting, two of which are shown in FIG. 27. Nine of the nodes are smart bolts, three in each blade of the wind turbine, and one more sensing vibration in a part, such as the gear box of the wind turbine. If each transmits for 5 mS, as shown in FIG. 27, then transmission from all ten nodes in sequence takes 50 mS. Each node logs data during that 50 mS. Thus, each data packet transmission from each node will include 50 mS of data logged from sensors in that node, and each node transmits a data packet 20 times per second. One transceiver suitable for low power operation is the Texas Instruments CC2420 transceiver, Dallas Tex., which features a data rate of 250 kb per second. Significantly higher data transmission rates can be obtained using a Nordic transceiver model NRF24L01 or an Ultra Wide Band (UWB) transceiver such as the DecaWave Dw4aSS100, Dublin Ireland. The Nordic transceiver can transmit data packets at 2 Mb per second and the UWB transceiver can transmit at 6.8 Mb per second. Thus, data can be transmitted from the three or more smart bolts in each of the blades of the wind turbine and from other sensors measuring vibration, such as vibration in the gear box, enabling real time adjustment of blade pitch and other parameters.

We estimate power consumption for each smart bolt with a Nordic radio transmitting data updating at 20 samples per second will be less than 120 uA on average. With the smart bolt equipped with the D cell from Tadiran the battery life can be calculated by the capacity of the battery, which is 19A-hours divided by 120 E −6=158,000 hours which is 18 years. The DecaWave radio will provide improved range when it becomes available for purchase in a few months.

Signals in addition to strain (or load) can be measured with the smart bolts of the present patent application. Triaxial accelerometers and rate gyros included in the instrumented sensor bolts permit determining:
Local vibration environment at the three blade roots
Shaft rotation rate
Shaft rotation angle
Individual blade pitch angle

While other sensors are currently used to measure shaft rotation angle and rate and blade pitch angles, providing sensors in bolts for measuring these parameters may be useful and may lower cost because integrating a variety of sensors in one easily added location can reduce installation and system complexity.

In addition, in one embodiment, blade root (or hub) vibration modes are also measured using strain gauges or accelerometers. Almost all other elements of the wind turbine such as the generator shaft, gearbox and tower already use vibration sensors (strain gages or accelerometers) for structural health monitoring. The present patent application thus provides a way to provide vibration data for a portion of the system not otherwise measured.

In addition, structural fatigue monitoring to prevent potentially catastrophic faults in rotorcraft and other structures is obtained by tracking load history with the synchronized energy harvesting wireless sensor nodes of the present application. A paper, “Extending HUMS to rotor systems,” by Kieran Daly, incorporated herein by reference, and published at http://www.flightglobal.com/articles/2009/02/16/322531/extending-hums-to-rotor-systems.html describes the problem with health and usage monitoring of rotors that is solved by the present patent application.

The health of vibrating machinery, such as gearboxes connected to rotors for helicopters and wind turbines, is also tracked using the sensor nodes of the present patent application.

Finally, temperature sensing can be important. In one embodiment the load sensors are temperature compensated. In addition, numerous temperature sensors are provided in the wind turbine system to monitor load sensor temperature, external air temperature, gearbox temperature, etc. In one embodiment, hub temperature is measured as a diagnostic, to early identify a maintenance problem or, for example, to identify a pitch servo controller that was overheating or that caught fire.

In a book: EMC for Product Designers, fourth edition, by Timothy Williams, ISBN 0-7506-8170-5 pages 421 to 423, several modes of lightning energy ingress to exposed electronic circuits are described.

Each of these entry modes has an individual protection solution. In an assembly like a bolt with embedded sensors that is to be mounted on a wind-turbine tower, lightning exposure potential is very high.

In the present invention, where electronics are entirely contained within a steel bolt, the exposure is predominantly limited to two categories.

In one category of entry mode, transient voltages are caused by current flowing through the resistance of the bolt. This produces a potential difference across the conductive surface of the bolt.

In another category of entry mode, electric and magnetic fields are induced by the current through the bolt and its inductive reactance at the frequencies where the maximum lightning transient energy exists.

For the case of the conducted voltage drop across the bolt resistance, if no direct connection is made between the bolt and the electronics, this threat is minimized. Strain gages used have a polyamide substrate with several thousand volts dielectric strength, making it possible to electrically isolate all of the electronics from the bolt structure.

For the high frequency electromagnetic radiated field components of a lightning transient event, a shielding sub-housing on the circuit board(s) is necessary. The exposure of the electronics from these effects is dependent on the size of the assembly and the length of any wiring, or circuit board traces used. By using a shielding sub-housing, current induced in the traces and wiring by this electromagnetic component, is shunted around the electronics.

Where battery operated electronics are used, conducted energy is not a concern for the power supply path. Where conductors from strain gauges or other external sensors enter the electronics, care must be taken to protect from electromagnetic transients induced on wiring. Various commonly used components, such as gas discharge tubes, Zener diode type transient voltage suppressors, and metal oxide varistors can be used to protect from these transients.

To summarize, mitigation of lightning is accomplished by isolating the electronics, i.e. no direct connection to the bolt, employing shielding sub-housing on circuit boards, and transient voltage limiting suppression devices applied to sensor wiring that must enter the sub-housing. In addition, when all the electronics is contained within an outline that is small relative to the wavelength of the electromagnetic transient, exposure is minimized.

### Instrumented Wind Turbine Tower

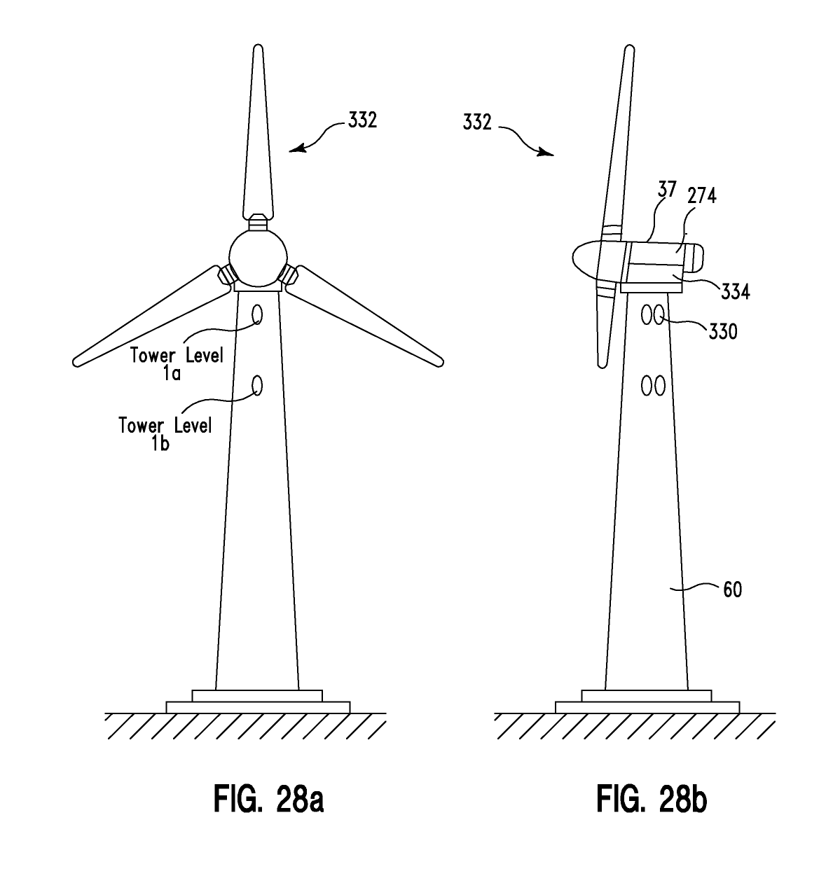

In one embodiment, a strain gauge package 330, as described in the '244 application, “Strain Gauge with Moisture Barrier and Self Testing Circuit,” is applied at three positions inside blade tower 60, as shown in FIG. 28, similar to the three positions in each blade 30, as described herein above. Strain gauge packages 330 bonded inside the tower are used to measure the total bending moments on tower 60. Strain gauge packages 330 are bonded at three positions 120 degrees apart. In another embodiment, three sets of strain gauge packages 330 are bonded at each of two known vertical heights within tower 60 to determine the transverse force against tower 60 which causes the moments measured by the two levels of sensors, as described in a paper, “A multiaxial force-sensing implantable tibial prosthesis,” by Bryan Kirking et al, Journal of Biomechanics, 39 (2006) 1744-1751, incorporated herein by reference. With this technique a more complete measurement of moments and forces on tower 60 as applied to rotor blade assembly 332 can be determined. The use of two levels is not required, but it would provide additional information.

Tower 60 has variable geometry, so a calibration is performed. In one embodiment, calibration is performed by measuring response of tower 60 before and after erection of generator assembly 334 that includes nacelle 37 within which is gearbox 274 and a generator. As a crane mounts generator assembly 334 onto tower 60 it's known weight and known center of gravity is used to calibrate response of strain gauges 330 in tower 60. Similarly measurements can be taken as other components are added to tower 60, such as rotor blades 30 with their known weight and moment arms. Alternatively, calibration can be performed by using a crane to provide known weights or forces to the top of tower 60 in known directions, for example known weights hung from pulleys. The response of strain gauges 330 in tower 60 is recorded in response to these known forces and moments. An appropriate transfer function is then stored in a memory in WSDA box 278. In yet another alternative, calibration of sensors used in the tower is performed on the ground prior to erection, or in the factory prior to shipment with known weights and moments.

In one embodiment, bending moments on tower 60 are measured. Since tower 60 supports blades 30 and the structure is in static equilibrium the bending moments on tower 60 must be equal to flapping moments on blades 30. Thus the present applicants recognized that the measurement of the bending moments in the tower can be used for continuous, in the wind calibration of the blade flap moments as measured by blade sensors 320a, 320b, 320c or by instrumented axial load-sensor bolts 50. The total moments measured by either of the blade sensors should be equal to the total moment measured by the tower sensors. This is useful for checking the validity of the blade mounted sensors.

In another embodiment, torque and RPM sensors are provided along the generator shaft, as described in the commonly assigned '505 patent, incorporated herein by reference. These sensors are used to obtain information about the lead-lag (edgewise) moments on the blades that cause the torque in the generator shaft. Thus, measurements of generator shaft torque and RPM can be used to validate the bolt sensor's measurements in this plane. Since the reaction force of the generator is unknown, this calibration check cannot be performed on a continuous basis. However, when the system is no longer spinning, then the laws of static equilibrium dictate that the torsional (edgewise) moments induced by the wind against the blades are completely resisted by an equal and opposite reaction torque in the main generator shaft. Thus, measuring the torque in the clamped generator shaft provides a measure of the torsional moment induced by the wind. If the turbine has been stopped, for example with a clamp located beyond the shaft torque sensors so as not to interfere with their measurement, then this torque measurement can be made and used as a check of the blade sensors' calibration in the edgewise plane.

In a further embodiment, by providing an RPM or angular velocity sensor on the generator shaft, the net input power at the generator's shaft can be determined. The power is equal to the torque times the angular velocity of the shaft. The input power measurement allows checking the overall efficiency of the generator itself, since the electrical output power provided by the generator depends on the input power and can also be measured. In the event of a significant drop in efficiency of conversion of the generator shaft power to electricity, the WSDA is programmed to send an e-mail or other alert via the internet or cell phone/satellite networks to the maintenance providers. In addition, the input power can be compared to a separate measurement of wind speed to determine whether the blades are properly transferring available energy to the shaft.

While the disclosed methods and systems have been shown and described in connection with illustrated embodiments, various changes may be made therein without departing from the spirit and scope of the invention as defined in the appended claims.

1. A turbine, comprising a turbine blade, a plurality of sensors and a wireless sensor module, a data aggregator, and a blade pitch control unit, wherein said plurality of sensors are distributed in a plurality of locations on said turbine blade suitable for determining a moment of said turbine blade, wherein said sensor module is configured to transmit data to said data aggregator to determine said moment, wherein said data aggregator is configured to provide an output to said blade pitch control unit, wherein said blade pitch control unit is configured to adjust pitch of said turbine blade based on said moment.

2. A turbine as recited in claim 1, wherein each said sensor module further includes an electronic circuit, wherein said sensor is connected to said electronic circuit, wherein said electronic circuit includes a processor.

3. A turbine as recited in claim 2, wherein said sensor electronic circuit includes a wireless communications device and wherein said data aggregator includes a wireless receiver.

4. A turbine as recited in claim 3, wherein said wireless communications device includes an RF transceiver.

5. A turbine as recited in claim 3, wherein said data aggregator is on a non rotating portion of said turbine, further comprising a hub, wherein said blade is connected to said hub, wherein said wireless sensor module is mounted in said hub.

6. A turbine as recited in claim 3, wherein said data aggregator is on a non rotating portion of said turbine, further comprising a plurality of said wireless sensor modules, wherein one of said plurality of wireless sensor module is mounted in each said location.

7. A turbine as recited in claim 6, wherein sampling of said plurality of sensors by said wireless sensor modules is time synchronized.

8. A turbine as recited in claim 1, wherein said blade moment includes at least one from the group consisting of flapping moment and edgewise moment.

9. A turbine as recited in claim 1, wherein said sensor includes a strain gauge.

10. A turbine as recited in claim 9, further comprising a plurality of smart fasteners, wherein each said smart fastener connects said turbine blade to said hub, wherein each said smart fastener includes one said sensor module.

11. A turbine as recited in claim 10, wherein each said smart fastener includes a plurality of strain gauges.

12. A turbine as recited in claim 11 wherein each said smart fastener includes a bolt, wherein said sensor module further includes an electronic circuit, wherein said plurality of sensors is connected to said electronic circuit, wherein said electronic circuit includes a processor and a wireless transmitter.

13. A turbine as recited in claim 12, wherein said sensors are positioned in said bolt to provide a measurement for use in determining said blade moment.

14. A turbine as recited in claim 13, wherein said strain gauge is oriented to measure strain along an axis of said bolt.

15. A turbine as recited in claim 12, wherein said bolt includes a pin portion and a housing portion, wherein said pin portion extends from said housing portion, wherein said strain gauge is mounted in said pin portion and wherein said electronic circuit is mounted in said housing portion.

16. A turbine as recited in claim 9, wherein said strain gauge includes a DVRT.

17. A turbine as recited in claim 1, wherein each said sensor module further includes an electronic circuit, wherein said sensor is connected to said electronic circuit, wherein said electronic circuit includes a processor, a memory, a clock, and a two-way wireless communications device, wherein said memory includes a program that provides same-time sampling by all of said sensor modules.

18. A turbine as recited in claim 17, further comprising a source of a beacon, wherein said memory includes a program for setting said clock to said beacon and initiating sample timing to provide for said same-time sampling.

19. A turbine as recited in claim 17, wherein said memory is connected for recording data, wherein said same-time sampling is at a rate exceeding 50,000 samples per second and uses less than 6 mj of energy for recording a byte of data.

20. A turbine as recited in claim 17, wherein said memory includes an FRAM.

21. A turbine as recited in claim 1, wherein said electronic circuit further comprises a source of power.

22. A turbine as recited in claim 21, wherein said source of power includes a battery.

23. A turbine as recited in claim 21, wherein said source of power includes an energy harvesting circuit.

24. A turbine as recited in claim 23, wherein said energy harvesting circuit includes a curvilinear linkage.

25. A turbine as recited in claim 23, wherein said energy harvesting circuit includes a flexure element having a mechanical disadvantage.

26. A turbine as recited in claim 25, wherein said flexure element has a diamond shape.

27. A turbine as recited in claim 1, wherein said data aggregator includes an aggregator processor and an aggregator memory, wherein said aggregator memory includes a program for using synchronous time stamped data from said plurality of said smart fasteners to determine a parameter of said blade.

28. A turbine as recited in claim 1, wherein said turbine further comprises a gear box, a second sensor, and a second electronic circuit, wherein said second sensor and said second electronic circuit are mounted on said gear box, wherein said second electronic circuit includes a processor, a memory, a clock, and a wireless communications device for communicating time stamped gear box data to said data aggregator.

29. A turbine as recited in claim 1, further comprising a device for communicating data derived from said sensor module external to said turbine.

30. A turbine as recited in claim 29, further comprising an internet server, wherein said device for communicating data externally communicates with said internet server.

31. A turbine as recited in claim 1, wherein said turbine blade is part of one from the group consisting of a helicopter and a wind turbine.

32. A system, comprising a plurality of wireless data collecting devices sampling simultaneously, wherein each of said plurality of wireless data collecting devices includes a real time clock and a receiver, further comprising a base station, wherein said base station includes a transmitter for transmitting a beacon for maintaining said real time clocks synchronous with each other, wherein said receiver is for receiving said beacon, wherein each of said plurality of wireless data collecting devices includes a processor and a memory, wherein said memory includes a program for sampling data on a schedule determined by time from said clock, wherein said schedule is the same for each of said plurality of wireless data collecting devices.

33. A system as recited in claim 32, wherein said beacon is for resetting and aligning said real time clock in each said wireless data collecting device with said beacon.

34. A system as recited in claim 33, wherein said beacon is broadcast on a schedule, wherein said receivers at each wireless data collecting device turn on in time to receive said beacon and then turn off.

35. A system as recited in claim 34, wherein receiver duty cycle is less than 1%.

36. A system as recited in claim 33, wherein each of said plurality of wireless data collecting devices includes an energy harvesting device.

37. A turbine as recited in claim 33, wherein each of said plurality of wireless data collecting devices is mounted on one from the group consisting of a structure, a bridge, helicopter and a wind turbine.

38. A wireless data collection and storage device, comprising a housing including a sensor, a processor, a clock, a high speed low power non-volatile data storage device, and a transceiver, wherein said a high speed low power non-volatile data storage device uses less than 6 nJ per byte of data stored in non-volatile memory when storing at a rate exceeding 50,000 samples per second.

39. A wireless data collection and storage device as recited in claim 38, wherein said a high speed low power non-volatile data storage device includes an FRAM.

40. A wireless data collection and storage device as recited in claim 38, wherein said a high speed low power non-volatile data storage device is included as a circular buffer.

41. A wireless data collection and storage device as recited in claim 38, wherein said sensor includes a strain sensor.

42. An energy harvesting system, comprising an energy harvesting device having a flexure element having a mechanical disadvantage, wherein said flexure element is precompressed and bonded exclusively at one end.

43. An energy harvesting system as recited in claim 42, further comprising a sensor, wherein said energy harvesting device is connected for powering said sensor.

44. An energy harvesting system, comprising a mechanical device, a magnet, and a coil, wherein said mechanical device includes linked flexure elements that provide curvilinear relative motion between said magnet and said coil.

45. An energy harvesting system as recited in claim 44 further comprising a pair of said magnets, wherein each member of said pair has same poles, wherein said same poles are held facing each other in said pair.

46. An energy harvesting system, comprising a pair of magnets, wherein each member of said pair has same poles, wherein said same poles are held facing each other in said pair.

47. An energy harvesting system for harvesting energy from a vibrating surface, comprising a resonant flexure element and an accelerometer, wherein said accelerometer is mounted to receive vibration energy from the vibrating surface and wherein said accelerometer is isolated from said resonant flexure element.

48. A wind turbine, comprising a wind turbine blade, a smart fastener, and a hub, wherein said smart fastener connects said wind turbine blade to said hub, wherein said smart fastener includes a sensor and an electronic circuit, wherein said sensor is positioned for sensing load on said smart fastener, and wherein said electronic circuit is connected to said sensor for receiving data detected by said sensor.

49. A method of sampling data, comprising:
providing a plurality of wireless nodes, wherein each said wireless node includes a receiver and a real time clock;
broadcasting a common beacon;
using said common beacon in each of said wireless nodes to synchronize said real time clocks; and
performing an action simultaneously in all said wireless nodes, wherein timing in each said wireless node is determined by said synchronized real time clock.

50. A method as recited in claim 49, further comprising providing a sensor in each said wireless node, wherein said action includes making a measurement with said sensor.
